(19) United States
(12) Patent Application Publication
(10) Pub. No.: US 2012/0109837 A1
(43) Pub. Date: May 3, 2012

(54) METHOD AND APPARATUS FOR MANAGING AND CAPTURING COMMUNICATIONS IN A RECRUITING ENVIRONMENT

(75) Inventors: Aaron Sahagun, San Francisco, CA (US); Allan Sahagun, San Francisco, CA (US); Geoffrey Lee, Orange, CA (US); E. Scott Swimley, Piedmont, CA (US)

(73) Assignee: ALUMWIRE, INC., SanFrancisco, CA (US)

(21) Appl. No.: 12/914,260

(22) Filed: Oct. 28, 2010

(51) Int. Cl. G06Q 10/00

(52) U.S. Cl. 705/321

(57) ABSTRACT

Method and apparatus described that can be applied to a job recruiting environment. A system can be configured to manage interactions between candidates seeking job positions and recruiters seeking to fill job positions. Using the central system, a candidate may be able to 1) search for different jobs, 2) upload work related information, 3) learn information about individual recruiters, 4) communicate with a recruiter and 5) maintain a network of connections including other candidates and/or recruiters. Recruiters may be able to 1) search through candidate provided information, 2) initiate a live communication with a candidate, 3) block or filter candidate communications, 4) receive a notification when a candidate may be available for a communication, 5) review prior communications with a candidate, 6) post a job description and a company profile, 7) manage a team of recruiters and 8) receive metrics and reports associated with recruiter activities and/or candidate characteristics.

### BACKGROUND

1. Field of the Invention

The invention relates to recruiting practices and in particular to communication management and capture in a recruiting environment.

2. Description of the Related Art

In the labor market, information regarding the availability of a large percentage of jobs is not widely disseminated. For instance, some experts suggest that up to 80% of jobs are not advertised using traditional methods. Viewed individually or in toto, recruitment needs can reveal important information about the health and direction of a company. Thus, although wishing to attract the most talented employees, for competitive as well as public relations purposes, companies often restrict how job related information is made available.

One method companies use to restrict and control the dissemination of job related information is via the use of recruiters. Recruiters can be part of an in-house organization or can be associated with an outside organization, such as a recruiting or an employment agency. A recruiter can be used to discreetly carry out a search for qualified job candidates that can be interviewed and ultimately hired. As part of being discreet, the recruiter may only provide limited information about a particular position, such as a brief job description and geographic location where the work is available, and limit the locations where the information is made available. Typically, a recruiter withholds more detailed information about the job opening such as a company name, an exact location and a more detailed job description until an individual is identified as a potential candidate for the available position.

A job recruiter's success depends on identifying a qualified pool of candidates. In the hiring process involving a recruiter, an employer is typically more satisfied if they feel that have 1) selected an individual to hire from a group of highly qualified candidates and 2) not wasted time interviewing candidates that are unqualified or not a good fit for the position. Thus, if a recruiter identifies a candidate that is ultimately hired, the recruiter is not only judged on the quality of the hired candidate but also on the quality of the rejected candidates.

The process of identifying a qualified pool of candidates that are interested in filling a position at any one time can be a time consuming and somewhat haphazard process. Recruiters as well as candidates each rely on informal networks of individuals and information sources that are constantly changing. When the informal networks of the recruiters and potential candidates that qualify for a position overlap and information of relevance to the potential candidate is received in a timely manner, i.e., a recruiter is attempt to fill an available position and this information is received by a qualified individual that is also interested in the position, then the recruitment process can proceed where a potential candidate becomes an actual candidate for a job position. The process of becoming an actual candidate can involve a more detailed series of communications between the recruiter and the candidate, including a dissemination of more detailed information about the job position, followed by one or more job interviews with a hiring manager.

The haphazard nature in the way recruiters and potential candidates are brought together results in many missed opportunities for both recruiters and potential candidates. To compensate, both recruiters and potential candidates have turned to modern communications channels, such as e-mail, text messaging, instant messaging, cell communications and social networking to reach out and expand their network with the hope of creating more opportunities for themselves. For a recruiter, the opportunities are finding and attracting a better pool of job candidates for a particular position. For a potential candidate, the opportunities are more and possibly a better selection of jobs.

A belief many individuals, including both recruiters and candidates, hold is that if they use modern communication technologies to send their information to more people, then more opportunities will be created. Contrary to this belief, in many ways, these communication technologies have made the problem worse. Although modern communication technologies allow information to be easily sent to a large number of individuals, the technologies have been generally applied in an unfocused manner. Recruiters and candidates alike are often deluged with unwanted communications including information that is not relevant or of interest. Therefore, a lot of time is wasted sorting through these communications to get to the information that is of interest. Thus, finding relevant information is still a haphazard process.

In view of the above, methods and apparatus and methods are needed that enable the communication processes between candidates and recruiters in a job recruiting environment to be better managed and more focused.

### SUMMARY

Broadly speaking, the embodiments disclosed herein describe relate to providing communication management and capture involving two entities. The two entities can be engaged in communications for business or social purposes. A few business examples are related communication management and capture for job recruiting, business to business sales, business to individual sales and technical support. Dating is one example of communication management and capture for a social purpose.

In particular embodiments, methods and apparatus are provided that allow the balance of communication between two entities to be adjusted and tuned to provide a more focused and efficient information exchange process. The balance of communication can involve but is not limited to 1) defining the communications that each entity is allowed to initiate and how the other entity is allowed to respond, 2) defining what information can be entered and exchanged in the communications, 3) defining the information that one or the other entity is allowed to view and 4) defining whether one or both of the entities are to be notified when it is determined whether one or both of the entities is available for communications. The communications between the two entities can be routed through a central system to allow information regarding individual communications such as a time, a date, the particular individuals involved and the content of the communications to be captured. The captured communications can be stored to allow for additional review and for legal and/or regulatory purposes. Further, the captured communications can be used to develop metrics. In one embodiment, the metrics can be used to evaluate one or both entities involved in a communication process.

In a particular embodiment, the method and apparatus described herein can be applied to a job recruiting environment where one entity includes candidates seeking a job positions and the other entity includes recruiters seeking to fill job positions. A central system for initiating, controlling and capturing communications and enabling information exchange between the candidates and the recruiters can be provided. Using the central system, a candidate may be able to 1) search for different jobs, 2) learn about different companies, 3) upload work related information, such as a resume or a work product, 4) upload personal information, such as hobbies, interests or other information that may distinguish them from other candidates, 5) learn information about individual recruiters, 6) post a message to a recruiter, 7) enter into a live conversation with a recruiter and 8) establish as well as maintain a network of connections including other candidates and/or recruiters. Recruiters may be able to 1) search through candidate provided information, such as resumes, 2) receive messages from candidates, 3) initiate a live communication with one candidate or a group of candidates, 4) block or filter candidate communications, 5) receive a notification when a candidate may be available for a communication, such as the notification that a candidate is on-line, 6) review prior communications with a candidate, 7) post a job description and a company profile, 8) post a recruiter profile for an individual recruiter, 9) manage a team of recruiters and 10) receive metrics and reports associated with recruiter activities and/or candidate characteristics on the central system.

Candidates and recruiters can enter the central system via separate communication gateways. The candidate gateways can be controlled by a particular entity, such as an alumni association or a company. For instance, an alumni site, which can be limited to alumni of a particular group or institution, such as a high school or a university, can host a micro-site, which may be a page on their main web-site. The micro-site can be configured as a gateway that allows alumni to enter into the central system described above. The central system can be configured so that information obtained from alumni entering through a particular gateway is only shared and available to certain recruiters. For example, the recruiters can be associated with companies selected by an alumni association.

As another example, a gateway can be controlled by a company. For instance, the gateway can be hosted as a micro-site on a company's web-site. Via the gateway, candidates can register and enter the central system to learn more about positions available at a particular company. In one embodiment, candidates entering through a company gateway may only see jobs associated with the company sponsoring the gateway. Further, information obtained from each candidate that has entered through a company's gateway may only be shared and made available to recruiters approved by the company.

In addition, in a particular embodiment, the central system can be configured to notify in real-time one or more individual recruiters associated with a company gateway when an individual has entered through the gateway. Based upon this notification, a recruiter can decide whether to initiate a live conversation with the candidate. The attempt to initiate communications and a subsequent live communication between the recruiter and the candidate, if it occurs, can be captured by the central system.

The central system can be configured to allow a recruiter as well as a staff manager for the recruiter to review information regarding initialization of a communication and content associated with an interaction when it occurs. Further, the system can be configured to provide metrics such as but not limited to what percentage of attempts at an initial communication actually lead to a live interaction, how long an average candidate spends on the system, an average length of interactions between recruiters and candidates on a recruiter by recruiter basis or for a recruiting team, a distribution of interaction time lengths, what percentage of live interactions lead to a follow-up communication with the candidate, demographics of associated with candidates that entered into a live communication.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1A is a block diagram of a system including candidates and recruiters in accordance with the described embodiments.

FIG. 1B is a block diagram of a system from the perspective of candidates, recruiters and the system in accordance with the described embodiments.

FIG. 2 is an illustration of a company gateway page in accordance with the described embodiments.

FIG. 3 is an illustration of a candidate home page in accordance with the described embodiments.

FIG. 4 is an illustration of a candidate profile page in accordance with the described embodiments.

FIG. 5 is an illustration of a candidate gateway page in accordance with the described embodiments.

FIG. 6A is an illustration of a candidate job search page in accordance with the described embodiments.

FIG. 6B is an illustration of tags that a candidate can associate with their profile in accordance with the described embodiments.

FIG. 7 is an illustration of a calendar page for a virtual career fair in accordance with the described embodiments.

FIG. 8 is an illustration of a candidate connections page in accordance with the described embodiments.

FIG. 9 is an illustration of a candidate resume loading page and resume management page in accordance with the described embodiments.

FIG. 10 is an illustration of a candidate message page in accordance with the described embodiments.

FIG. 11 is an illustration of a recruiter home page in accordance with the described embodiments.

FIG. 12 is an illustration of a candidate/recruiter live communication interface in accordance with the described embodiments.

FIG. 13A is an illustration of a recruiter candidate note page in accordance with the described embodiments.

FIG. 13B is an illustration of a recruiter candidate information search page in accordance with the described embodiments.

FIG. 14 is an illustration of a recruiter job posting page in accordance with the described embodiments.

FIG. 15 is an illustration of a staff management page in accordance with the described embodiments.

FIG. 16A is an illustration of a community page in accordance with the described embodiments.

FIG. 16B is an illustration of a community manager page associated with the described embodiments.

FIG. 17 is a flow chart of a method of communication management and capture involving recruiters and candidates.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

Methods and apparatus are described that can be used to make the recruiting process more efficient and less haphazard. The process can be made more efficient by controlling a balance of communication between candidates and recruiters. Toward this end, a system is described that can be used to control communication interactions and information availability in a recruiting environment. The system can include different communication tools and information access for recruiters and candidates. In some embodiments, recruiters can be provided with more control over the communication process and more information access than candidates. Further, the system can be configured to limit the potential interactions and information flow between candidates and recruiters. In this way, unfocused communications by candidates can be lessened allowing the overall recruiting process to become more efficient.

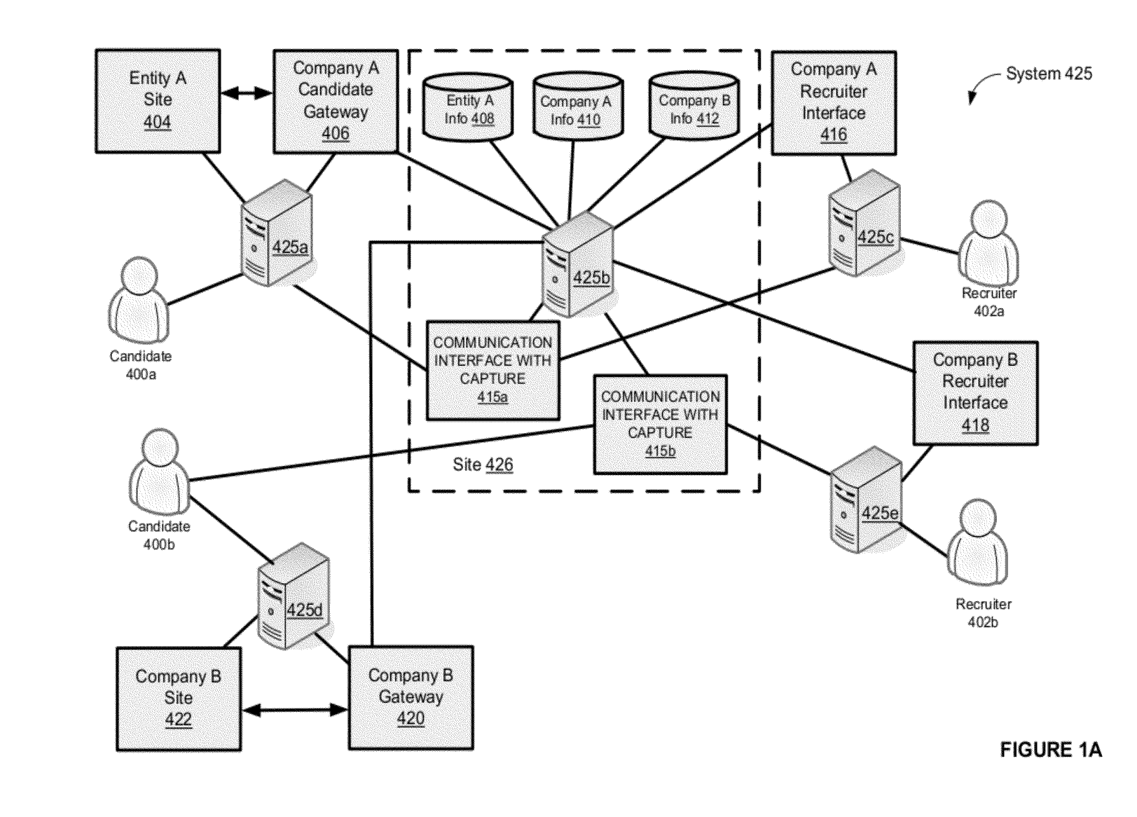

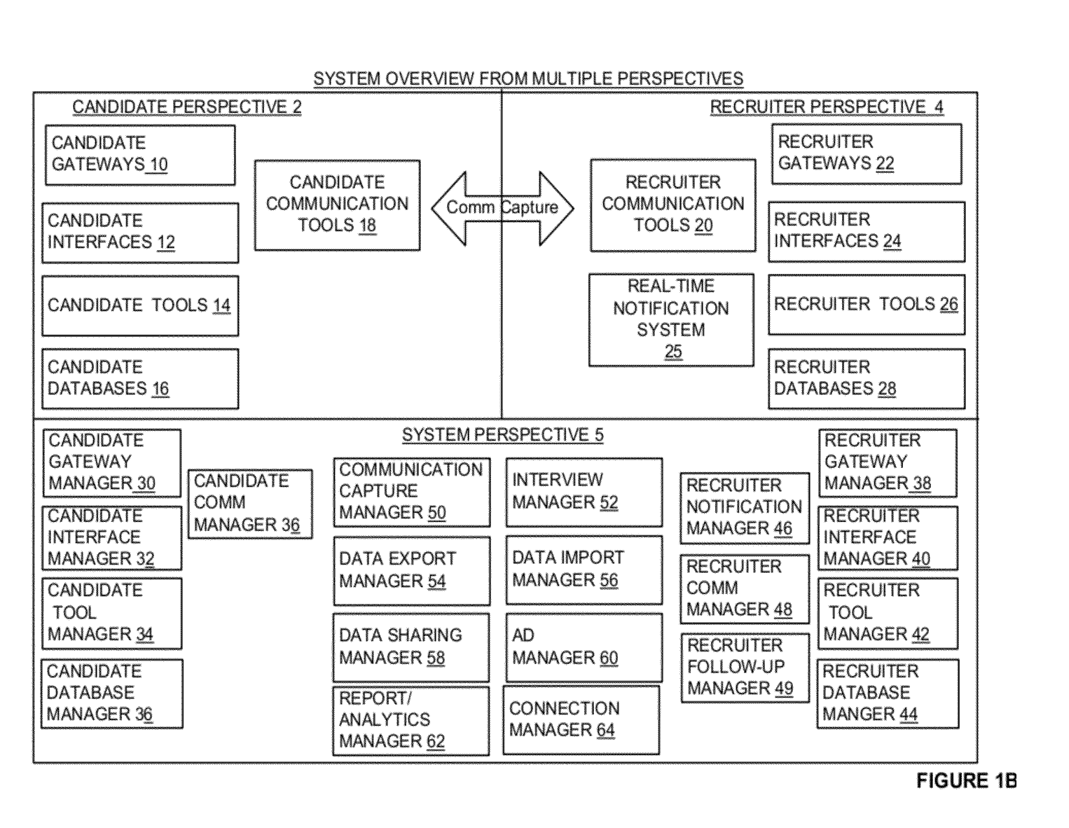

The method and apparatus are described with respect to a number of Figures. In particular, an exemplary interaction between recruiters and candidates is described with respect to FIG. 1A. Then, with respect to FIG. 1B, a system overview from the perspective of candidates, recruiters and the system management is discussed. Next, with respect to FIGS. 2-10, the system is primarily described from a candidate's perspective. For instance, candidate gateways into the system, candidate interfaces, candidate tools and interactions that candidates can initiate with recruiters are described.

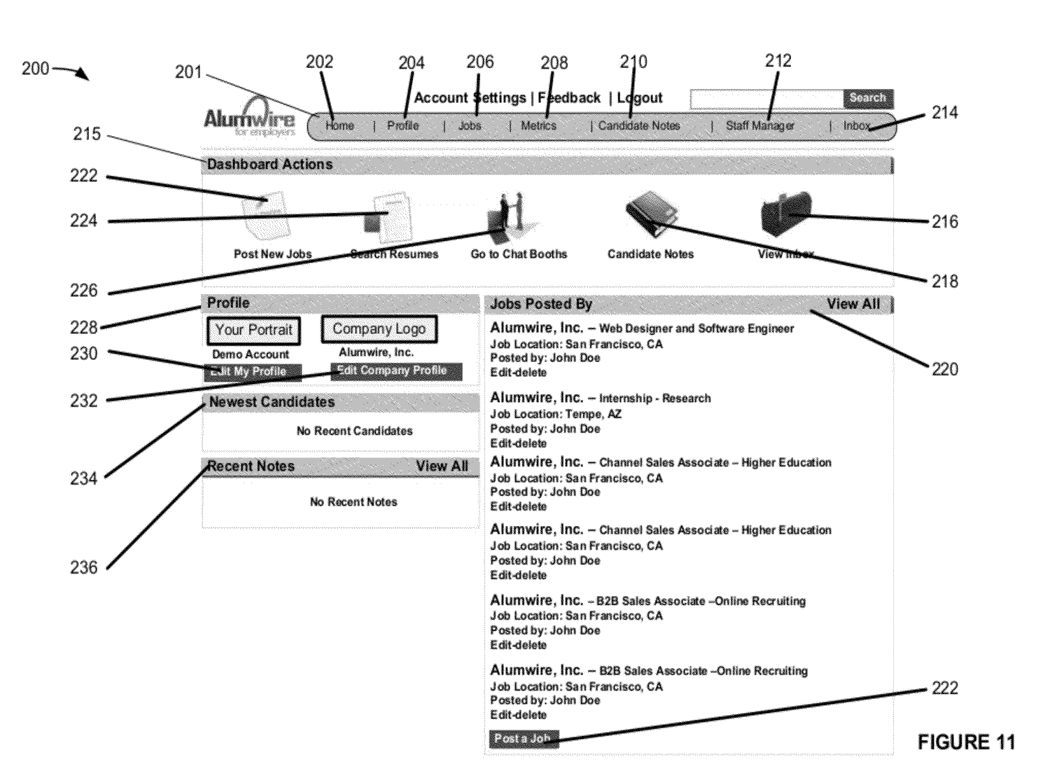

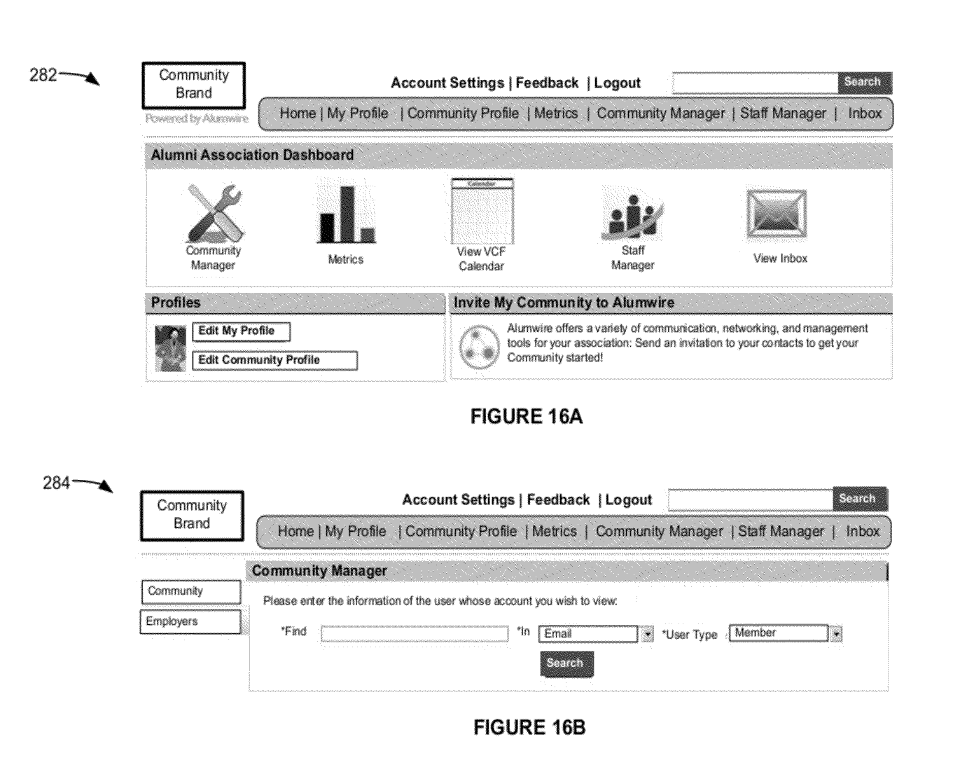

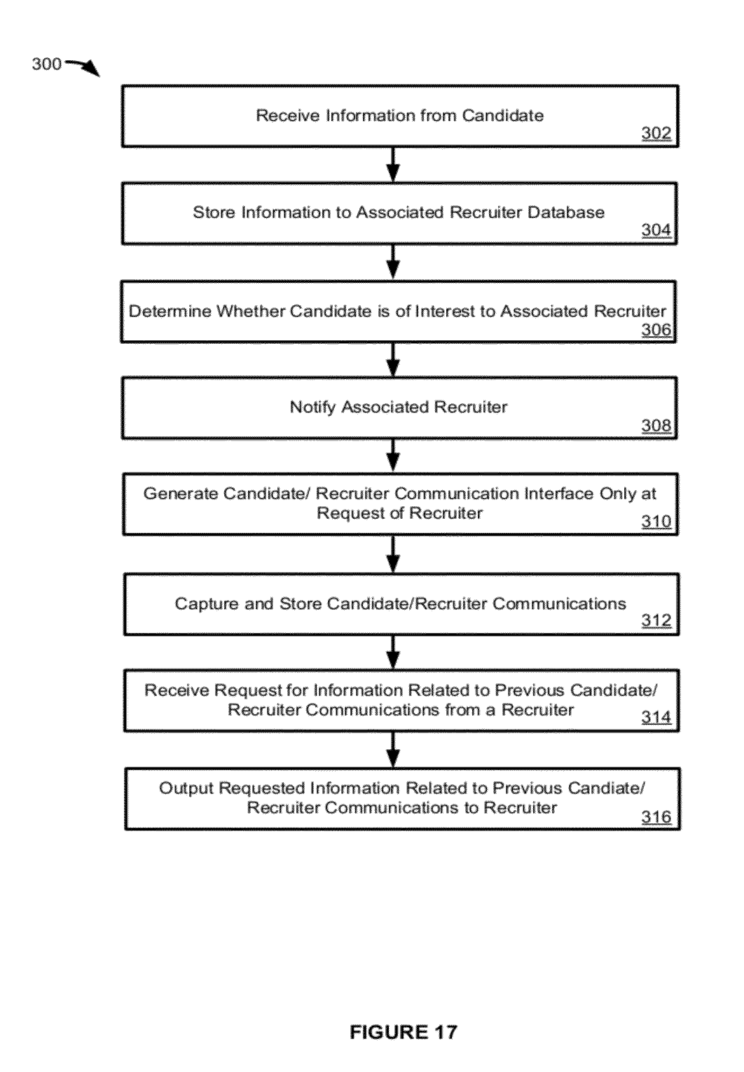

With respect to FIGS. 11-15, the system is primarily described from a recruiter's perspective. Thus, recruiter gateways into the system, recruiter interfaces, recruiter tools and interactions that recruiters can initiate with candidates are described. Next, with respect to FIGS. 16A and 16B, an interface for managing a community of candidates, such as an alumni associated is discussed. Finally, with respect to FIG. 17, a method of managing and capturing communications between recruiters and candidates is discussed.

FIG. 1A is a block diagram of a system 425 for performing recruiting tasks, such as managing and capturing communications between candidates and recruiters. A brief description of the devices that can be utilized in the system 425, processes performed by the system and a few examples of how recruiters and candidates may access the system and interact are described as follows. Further details of the system 425 from candidate, recruiter and system perspectives are described with respect to FIG. 1B.

The computing resources used to perform various tasks including processing and storing data associated with the system 425 can be provided using various types of computational devices. The number and type of computational devices and associated network topology shown in FIG. 1A is provided for the purpose of illustration only and is not meant to be limiting. As an example, servers, such as servers 425a, 425b, 425c, 425d and 425e, are one type of computational device that can be used in the system 425. Each server can include at least one processor, memory and network interface. Desk-top computers, lap-top computers, tablet computers, cell phones and gaming systems are other examples of computational devices that can be used host processes associated with system 425. For instance, a candidate can use their cell phone to participate in a communication with a recruiter that is captured by the system.

As noted above, the system 425 can be configured to perform various processes associated with recruiting including managing and capturing communications between recruiters and candidates. As shown in FIG. 1A, the processes can be distributed among multiple computational devices. Examples of processes can include but are not limited 1) generating candidate and recruiter interfaces, such as interactive communication interfaces, 2) storing, retrieving and processing candidate and recruiter information and 3) managing social/business connections for candidates and recruiters. Next, a few examples in which candidate and recruiters can utilize system 425 are described.

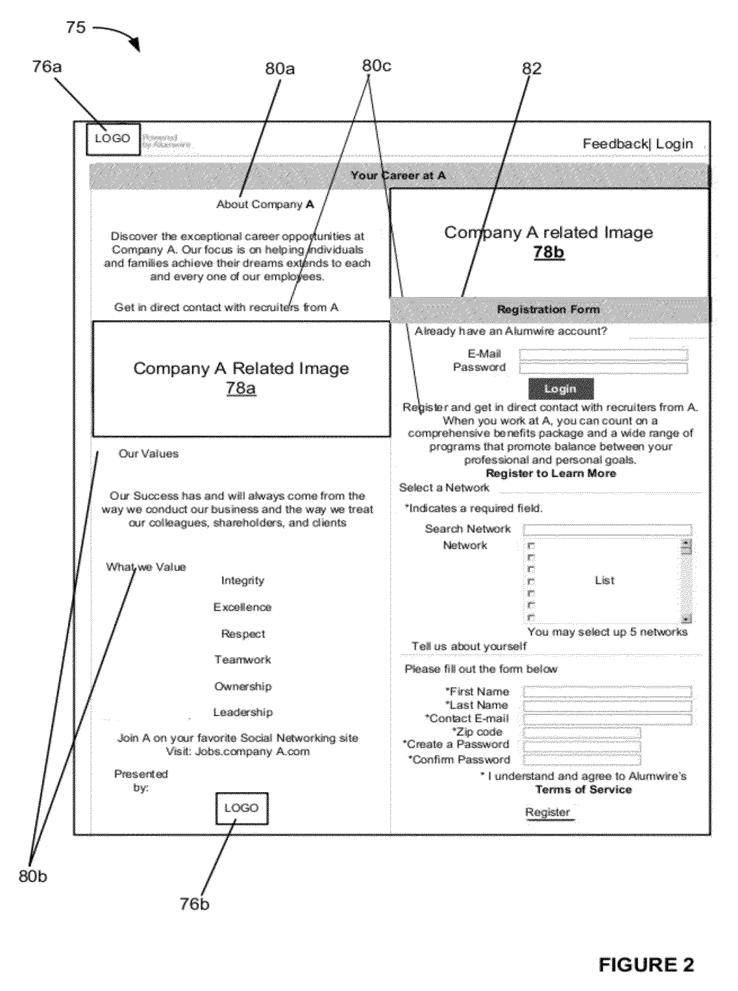

In particular embodiments, distinct interfaces can be generated for candidates, such as 400a and 400b, and recruiters, such as 402a and 402b, where different tools and capabilities can be provided for each of the recruiters and the candidates. Candidate tools and interfaces are described in more detail with respect to FIGS. 3-10. Recruiter tools and interfaces are described in more detail with respect to FIGS. 11-15. As described above, the respective candidate and recruiter interfaces can be tuned to allow for more efficient communications to occur between the candidates and the recruiters.

In one embodiment, the recruiter and candidate interfaces can be web-compatible and reachable through a data network. As an example, to learn about a job, a candidate, such as 400a or 400b, via an available computing device, can navigate to an entity's site 404 hosted on device 425a. The device 425a can be configured to host a micro-site, such as a gateway 406, related to jobs provided by a company, such as company A. The entity can be a community, such as an alumni association that provides services, such as jobs, to its members. In another example, a candidate, such as 400a or 400b, can navigate to a company's site, such as company B site 422, to learn about a jobs that are generally provided and possible currently available at company B. The device 425d can be configured to host a general site for the company as well as a micro-site, such as gateway 420, related to jobs by company B.

The gateway sites 406 and 420 can include company information and an indication that additional information about the jobs available about the company including a chance to interact with recruiters for the jobs is available if the candidate enters into another site, such as a site 426 hosted by device 425b. The candidates can be invited to supply additional information that can be useful in the recruiting process. Some information can be provided at the gateway site and additional information can be provided after the candidate is directed to the site 426 hosted on 425b.

As an example, at a gateway site, such as 406 and 420, a candidate can be invited to register for an account at site 426. As part of the registration process, the candidate can provide initial information. Then, after entering site 426, via their account, the candidate can supply additional information, such as job related information associated with a resume. More details of a gateway site embodied as a web-page are illustrated and described with respect to FIG. 2.

Prior to the candidates, such as 400a and 400b, entering site 426, information about the candidate entered from the gateways 406 can be sent and stored on site 426. The information obtained from a candidate can be associated with different entities where access to candidate information can depend on an affiliation of a candidate or a recruiter with the one or more entities. For instance, information about candidates associated with a first entity, such as Entity A, which may for example be an alumni association, can be stored in a first database 408. Candidates associated Entity A may be able to learn information about other candidates associated with Entity A, but may not be able to learn information associated with other entities, such as members of alumni associations to which they do not belong.

Recruiters associated with Entity A may be able to see candidate information in 408. For instance, recruiter 402a may be associated with entity A but recruiter 402b may not be associated. Thus, recruiter 402a may be able to learn about candidates associated with entity A but recruiter 402b may not be able to learn about the candidates in Entity A. System managers at site 426 may have access to all of the information at the site 426.

The candidate information from candidates entering through the company A gateway 406 may be stored in a database associated with company A 410 and the candidate information from candidates entering through the company B gateway 420 may be stored in a database associated with company B. Recruiter 402a can be associated with company A and thus, can be granted the privilege of seeing candidate information in 410 via an interface 416 provided through device 425c in conjunction with device 425b. Recruiter 402b can be associated with company B and thus, can be granted the privilege of seeing candidate information in 412 via an interface 418 provided through device 425e in conjunction with device 425b. The site 426 can be configured such that recruiter 402a is not able to see candidate information in 412 and recruiter 402b is not able to see candidate information in 410.

After a particular candidate, such as 400a and 400b, enters site 426, the candidate can be invited to enter additional information via a candidate interface (not shown) provide at site 426. For instance, a particular candidate can be invited to enter job related information, such as a resume, or personal information, such as information about personal interests. The information entered by a particular candidate can be stored to particular databases and described in proper detail such that access privileges to the information for various individuals, such as other candidates and recruiters, is properly maintained.

In particular embodiments, the site 426 can be configured to notify recruiters in real-time when a candidate is on-line, such as when the candidate has navigated onto site 426. In response to the notification, the site 426 can be configured, at the request of a recruiter, to instantiate an interface that allows for a live communication between the candidate and the recruiter. For instance, candidate 400a and recruiter 402a can enter into a live communication via interface 415a and candidate 400b and recruiter 402b can enter into a live communication via interface 415b. Portions of the communication interface can each be provided via devices available to the candidate and the recruiter respectively. Communications generated via the use of interface 415a and 415b can be captured on site 426 and stored to an appropriate database. In one embodiment, the site 426 can be configured to allow only recruiters to subsequently retrieve and review candidate-recruiter communications.

Next, with respect to FIG. 1B, further details of the system 425 are described from the perspective of candidates, recruiters and the system. From the candidate perspective 2, candidates can be provided gateways 10 that allow them to learn about job opportunities at different companies and possible interact with recruiters associated with the company. The candidates can be provided with interfaces 12 that provide a structure for utilizing the various functions provided the system. The interfaces can be compatible with different devices, such as a candidate's smart phone or a candidate's home computer.

Various tools 14 with different functions can be provided to candidates via interfaces 12. For instance, candidates via the interfaces may be able to upload job-related and personal information, manage this information, search for jobs, establish and manage connections with other candidates and recruiters and interact with other candidates and recruiters. Candidate accessible information can be stored and retrieved from candidate databases 16. Candidate communication tools 18 can be used to allow candidates to communicate with one another and recruiters.

As described in more detail below, the type and amount of information available to candidates and recruiters differ. For instance, candidate may able to see their own resume information but not other candidate information. Recruiters may be allowed to see resume information from multiple candidates. However, each recruiter may not be allowed to see every candidate resume in the system. Different recruiters may be allowed to access different sub-sets of candidate data in the system according to privileges granted to them by an entity, such as community or a company, or as a result of the development of their own practice as a recruiter. Next, the system is described in some detail from the perspective of a recruiter.

From the recruiter perspective 4, recruiters can enter the system via recruiter gateways 22. In one example, a recruiter gateway can include a login page. Different login pages can be generated for different groups of recruiters. The recruiter gateways 22, as well as account information associated with each recruiter, can be used to set the access privileges for recruiters, such as allowing the recruiters to see information regarding a portion of the candidates in the system.

In one embodiment, a community, such as an alumni association, can provide a recruiter gateway that allows recruiters to enter into their community, see information regarding members of their community and possibly interact with members of their community. A community manager function can be used to control access of the recruiters to the community. For instance, via the community manager function recruiters can be added or removed from the community. Recruiters can be representative of companies. In one embodiment, access can be granted to the community in terms of companies where access to the community for a particular company allows the company to select company representatives, such as recruiters, to enter the community. More details of community management are described with respect to FIGS. 16A and 16B.

The recruiters 24 can be provided with interfaces that allow them to learn about different candidates and initiate interactions, such as live communications with candidates. The interactions between the recruiters and candidates can be initiated using the recruiter communication tools 20 which can be integrated into the recruiter interfaces 24. The interactions can be captured by the system and stored to recruiter databases, such as 28. Via use of the recruiter tools 26, the recruiters can search for and retrieve information from the recruiter databases about past interactions captured by the system.

Further, using the recruiter tools 26, a recruiter can search candidate databases to identify candidates that may be to fill a particular job. In addition, a recruiter can post a job that can be made visible to candidates via the candidate interfaces 12. Furthermore, the system can be configured to allow a recruiter to manage connections with other recruiters and candidates. Also, via tools 26, a staff manager can manage a team of recruiters. In one embodiment, the system can be configured to provide metrics to the staff manager that allows them to evaluate both the performance of a recruiting team and the performance of individual members of the recruiting team.

In one embodiment, a real-time notification system 25 can be provided to recruiters. The real-time notification system 25 can be used to notify a recruiter when a candidate of interest to the recruiter is interacting with the system. In response to the notification, the recruiter can use the recruiter communication tools 20 to attempt to communicate with the candidate. For example, the communication tools 20 may allow the recruiter to enter into a video chat with the candidate. Next, a system perspective is described.

From the system perspective 5, the system can include a candidate gateway manger 30 for managing a number of candidate gateways. For instance, the system can support a gateways associated with a number of different companies. The gateways can be micro-sites that are placed within with a company's main web-site. As another example, a community can host a number of micro-site associated with different company gateways within the main web-site associated with the community.

The candidate interface manger 32 can control the interfaces generated for the candidates. The candidate tool manager 34 can control the instantiation of various tools provided to the candidates. The candidate database manager 34 can control the storing and retrieval of information received from candidates and access to an individual candidates own data.

The recruiter gateway manager 38 can be used to generate and control various gateways made available to recruiters. Different recruiter groups, such as a recruiter group associated with a particular company, may each be provided custom gateways. In one embodiment, a recruiter gateway can be provided as an entrance to a community. The recruiter interface manager 40 can manage the interfaces provided to different recruiter groups. The recruiter tool manager 42 can generate and implement various tools that are provide to recruiter, such as candidate searching, communication control, job posting and recruit staff management. The recruiter database manager 44 may allow different data sets to be associated with different individual recruiters or recruitment teams to be stored and retrieved in a segregated manner.

The recruiter notification manger 46 can be configured to notify an individual recruiter or a team of recruiters when a candidate of interest to them is potentially available for a live interaction. For instance, the recruiter notification manger 46 may notify a recruiter at their computer when a candidate of interest has logged onto the system. The recruiter communication manager 48 may manage the communication tools that are available to recruiters. The functions of the communication tools that are provided to candidates can differ from those of recruiters. For instance, the system can allow recruiters to initiate certain communication modes, such as an interactive whiteboard, and not candidates.

The recruiter follow-up manger 49 may allow a recruiter and/or a staff manager to schedule follow-ups with candidates and track whether a follow-up communication has occurred or not. The communication capture manager 50 can be configured to capture the content associated with a live communication between a recruiter and a candidate as well as meta-data associated with the communication, such as participants and when the communication occurred. The interview manager 52 may allow a recruiter to schedule an interview with a candidate and track whether it has occurred or not. The interview can be between a candidate and a recruiter or a candidate and a hiring manager at a company.

The data export manager 54 may allow a recruiter or candidate to export data from the system for another application. The data import manager 56 may allow a recruiter or candidate to import data into the system. For instance, a recruiter may be able to import and maintain data associated with candidates, such as resumes that they have previously received. The data sharing manager 58 may allow candidates and recruiters to share information. For instance, the data sharing manager 58 may allow one recruiter to share their proprietary candidate information with another recruiter.

The ad manager 60 may be configured to host adds on the system. The ads can be targeted to specific groups of candidates. For example, candidates associated with an alumni association can receive adds for goods and services that are of particular interest to their association, such as alumni related paraphernalia or alumni events. The report/analytics manager 62 can be used to generate reports and various metrics that can be interest to a recruiter or a recruiter team, such as demographics of candidates and success at recruiting candidates with particular demographics. The connection manager 64 can be used by recruiters and candidates to establish and mange their connections on the system.

Next, further details of the system are described. In particular, an exemplary gateway page is discussed with respect to FIG. 2. Interfaces, tools and the function of the system associated with candidates are described with respect to FIGS. 3-10. Then, interface, tool and the function of the system associated with recruiters are described with respect to FIGS. 11-15.

FIG. 2 is an illustration of a company gateway page 75 for a candidate. In one embodiment, the company gateway page 75 can be hosted on a company's web-site as a micro-site. An individual can navigate to the company's web-site and then look for job information. A search for job information can lead a candidate to the company gateway page 75.

In another embodiment, as is described in more detail with respect to FIGS. 16A and 16B, the candidate can be part of a community, such as a student-alumni association for a university. A community, such as an alumni association, can allow one or more entities, such as a company to sponsor gateway pages on their site. For instance, within a community's site, a page can be provided with links to a number of different companies. A member of the community may navigate to the page with the links in search of information about companies as part of a job search. A selection of one of the links can lead to a company gateway page, such as 75. As is described in more detail below, each company gateway page 75 can be linked to the central system described with respect to FIGS. 1A and 1B.

In particular embodiments, the company gateway page 75 can include branding, such as company logos, 76a and 76b. Further, the gateway page 75 can include images associated with the company, such as but not limited to images of products the company provides, images of work or services that the company provides and images of people selected to be representative of the company, such as images of employees performing different jobs at the company. In additional embodiments, the gateway page 75 can include information, such as a company profile 80a and company values 80b.

The gateway page 75 can be configured to indicate that an individual, such as a candidate, can learn more about jobs at a company by registering 82 or logging in if they have previously registered with the gateway. The gateway page can be configured to indicate that registering and/or logging in can result in an interaction with a company affiliated recruiter (e.g., see 80c). The registration process can include providing one or more of a name, a contact e-mail address, a zip code and a password. Further, the registration process can require a candidate to enter individual networking information, such as one or more groups of which a person is associated. A school and a professional group are two examples of networking related information that a candidate can be allowed to select. In example in FIG. 2, an individual is allowed up to 5 selections.

After logging in or registering, a candidate can be granted access to additional job information and potential access to recruiters. For example, after logging in or registering, a candidate can be directed to a page listing available jobs and recruiters associated with the company (see e.g., FIG. 3). This access may not be immediately or automatically granted. For instance, a confirmation e-mail or text can be sent to an e-mail or text address, the candidate supplied. The confirmation e-mail or text can be configured so that a response is required using information contained in the confirmation message. When the candidate responds properly, then the account access can be granted and the candidate can be directed through the gateway to the central system.

In another embodiment, the central system can be configured to perform other filtering mechanisms before an individual is passed through a gateway to the central system. For instance, the filtering can be based on information the individual has provided, such as the networking information or zip code information. Further, the central system can be configured to do a data consistency or confirmation checks, such as determining whether a person with the last name can be located in the listed zip code that the candidate has provided.

In particular embodiments, candidates can be required to enter through a particular entity's gateway page if they want additional access to recruiters and job information associated with the entity. For instance, a candidate can go to a first company gateway page, such as 75, and register and/or login, and then be directed to a page on the central system that allows a person to learn about jobs and interact with recruiters only associated with the first company. The recruiters associated with the first company may be notified when the candidate enters through the first company's gateway. Then, the candidate can go to a second company gateway page and login through this page and then be directed to a page that allows the candidate to learn about jobs and interact with recruiters only associated with the second company. The recruiters associated with the second company can be notified when the candidate enters through the second company gateway but not the recruiters associated with the first company.

In one embodiment, the recruiters at the first company or the second company may only gain access to the candidates job related information after the candidate has entered through the company's gateway. For instance, after the individual enters the central system through the first company's gateway, recruiters with the first company can be allowed to search for and view the candidate's information. However, the recruiters at the second company can be denied access to this information (e.g., it may be simply invisible to them at the central system) unless the candidate enters through the second company's gateway.

In a particular embodiment, the recruiters at a particular company may not be allowed to contact an individual with information at the central system until the individual has entered through the particular company's gateway. Further, data associated with different recruiters can be segregated such that one group of recruiters is not able to determine whether a candidate is associated with other recruiters, see candidates associated with other recruiters or be notified when an candidate associated with other recruiters is on the system.

In other embodiments, a recruiter team associated with an entity can be granted a privilege which allows them to determine, such information as whether the candidate is visible to other recruiters (this information can be provided with/without identifying the other recruiters) and if so, how many other recruiters. In addition, the privilege may allow a recruiter to be notified when the candidate has talked to another recruiter. This information can include or not include a time and date of the conversation, information about the job position and again may or may not specifically identify the other recruiters.

In yet other embodiments, a community can agree to allow a group of entities, such as companies, to have access to candidate information prior to individual candidates entering through a company gateway. For instance, a student and/or alumni associated community may allow companies listed on their site to view information posted by the individuals prior to the individual entering through the company's gateway. In one embodiment, however, each company may not be allowed to contact an individual associated with the community until the person has entered through their particular gateway or has somehow indicated that they are interested in the particular company (e.g., the community site may be configured to allow an individual to select companies in which they have interest). In another embodiment, each company may be allow to contact an individual associated with the company prior to the person entering through the particular company's gateway or expressing interest in the particular company.

Next, details of a candidate interface configuration at the central system are described with respect to FIGS. 3-10. As an example, a candidate interface configuration can be generated after a candidate has logged in or registered as is described above with respect to FIG. 2. FIG. 3 includes an example of a home page that can be generated. The home page includes links to other pages. Details of some of these linked pages are described in detail prior to the finish of the discussion of FIG. 3. Thus, FIG. 3-10 are not discussed in numerical order.

FIG. 3 is an illustration of a candidate home page 100 in accordance with the described embodiments. In particular embodiments, he home page includes selected areas that allow a user to return to the home page 102, view and/or edit their profile 104, view and/or edit resume 106, view employer opportunities 108, view and manage their network connections 110 and view and possibly generate messages 112. In one embodiment, these selectable areas can be repeated on each candidate page as the candidate navigates away from the home page 100. The selectable areas that are described are provided for illustrative purpose only and other combination of selectable areas including selectable areas with different functions are possible.

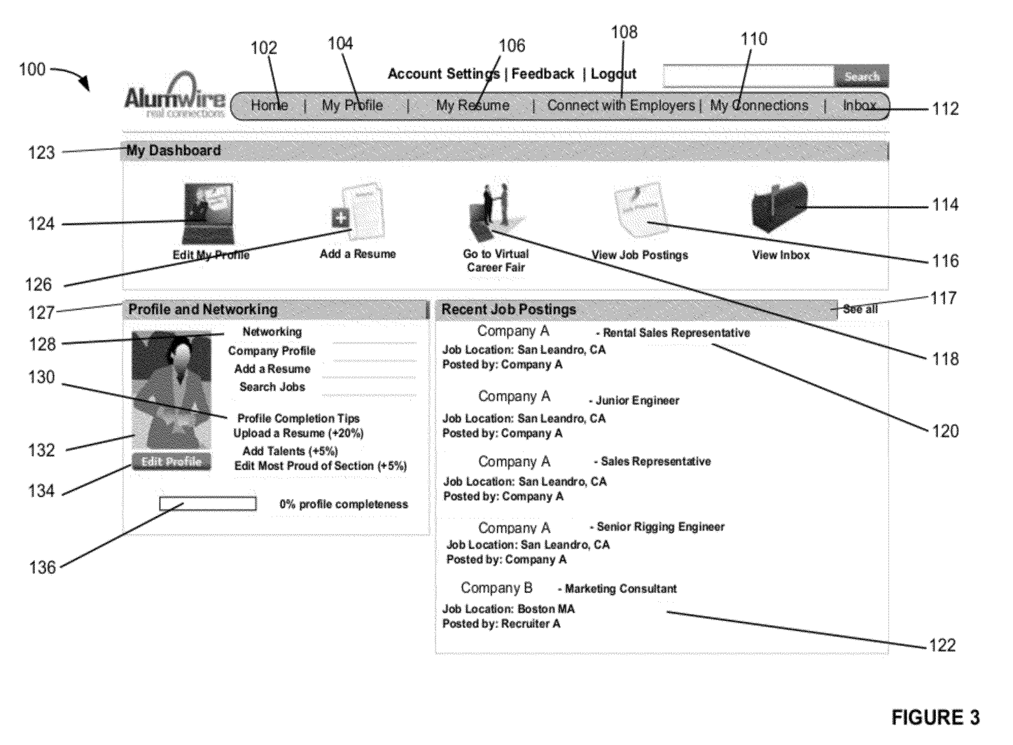

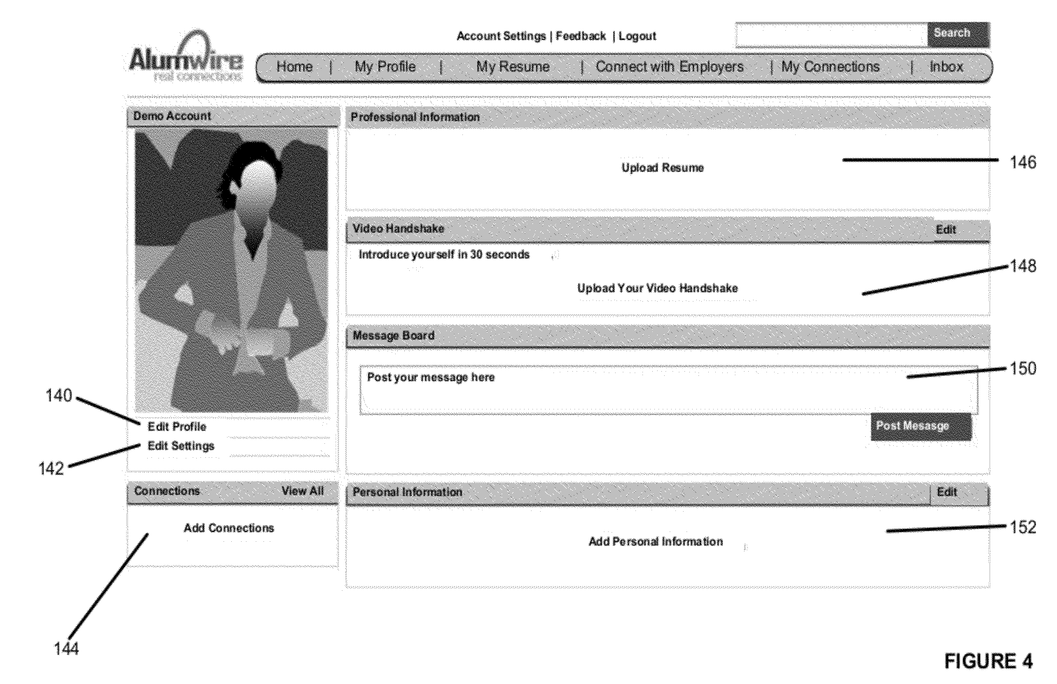

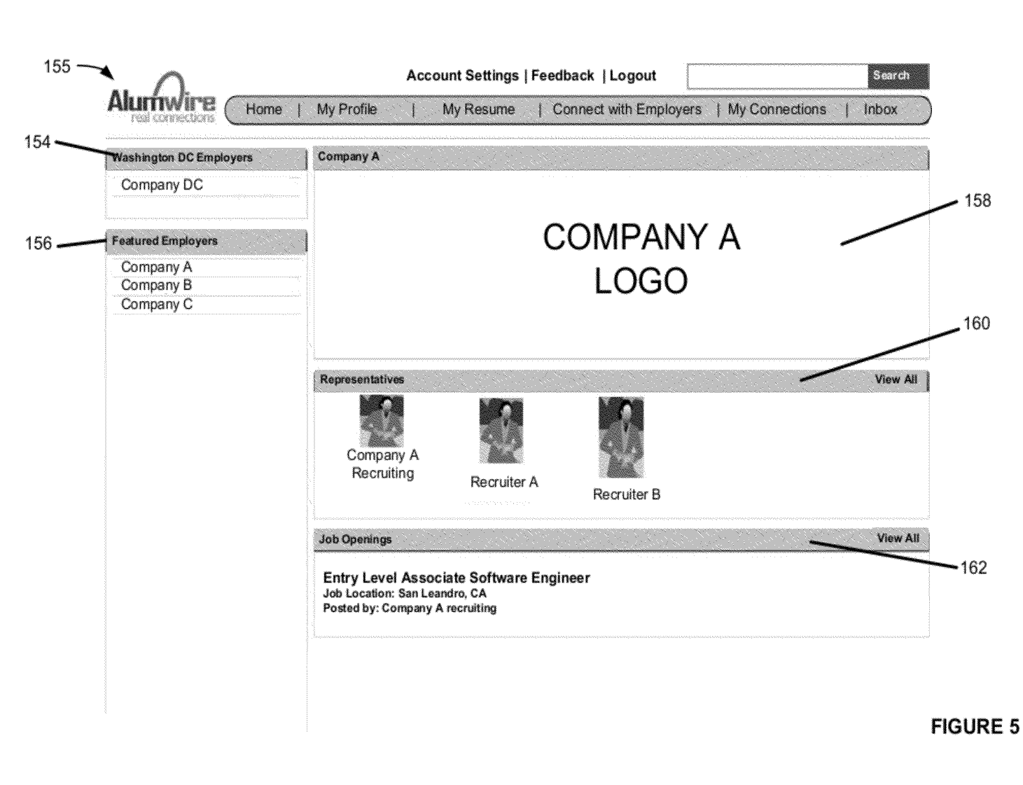

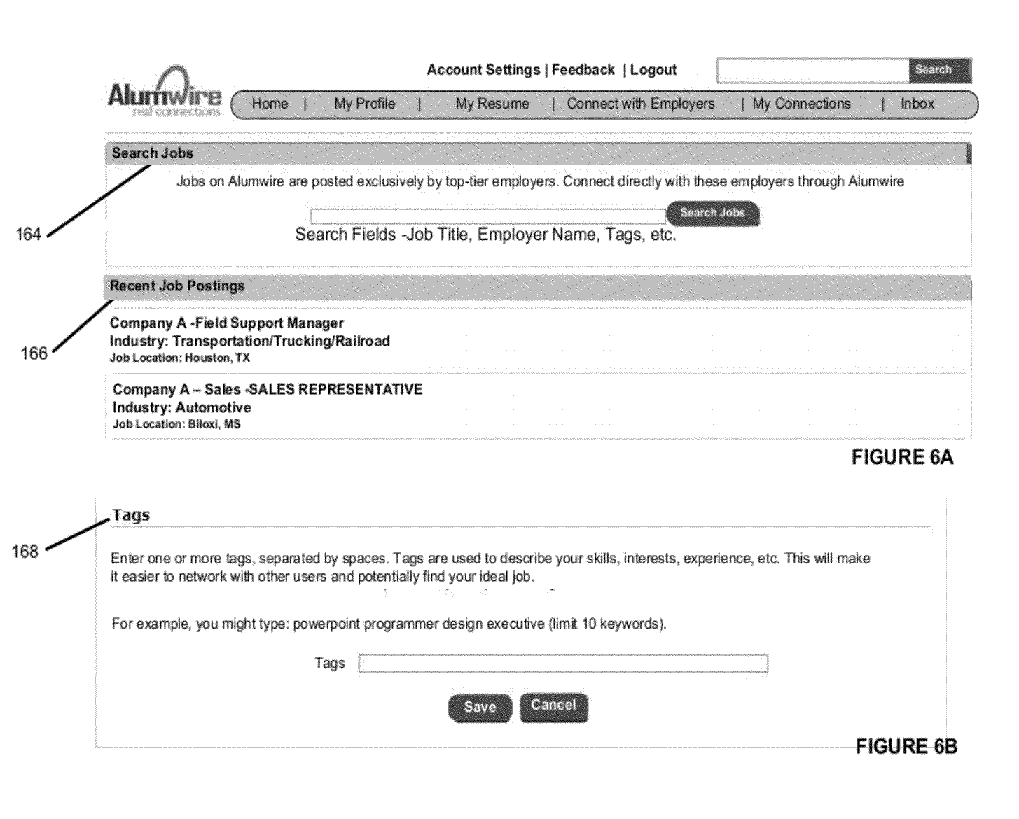

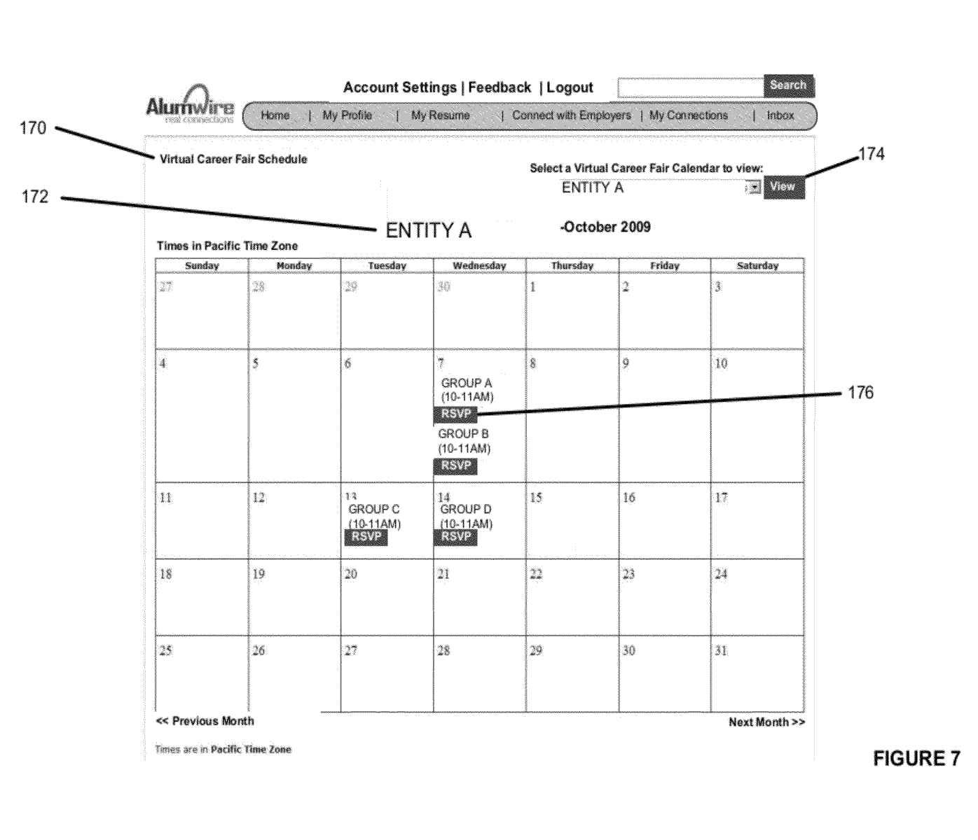

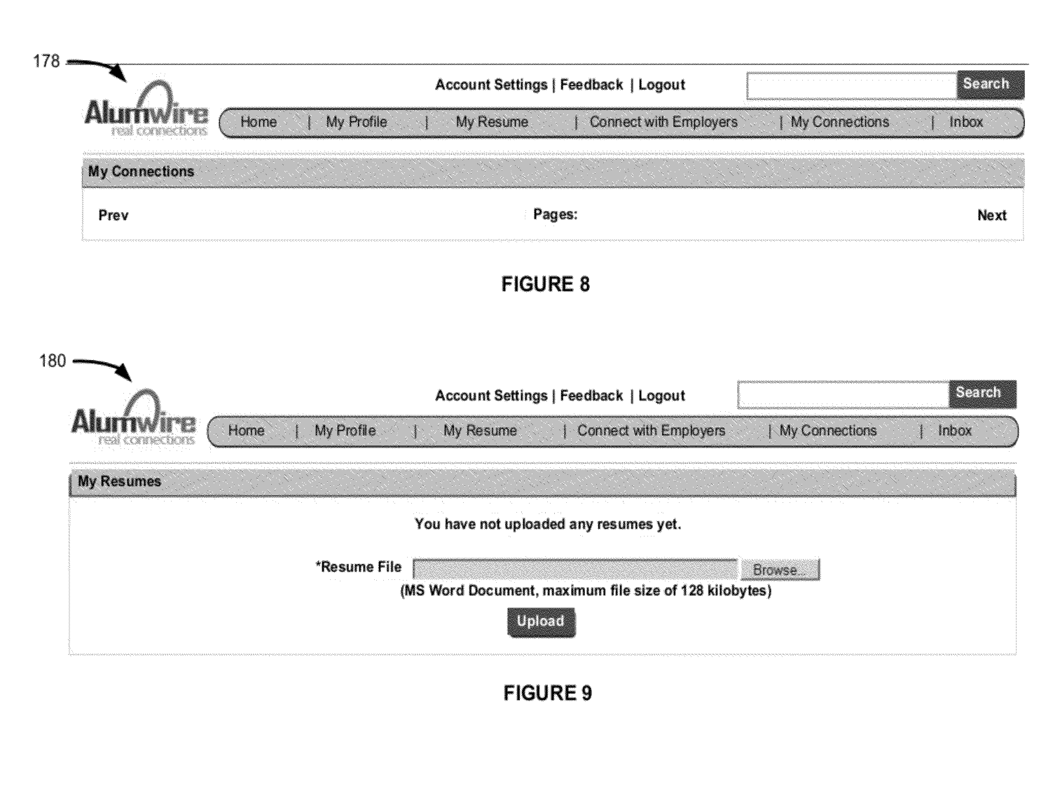

The selectable areas at the top of the page can be associated with pull down menus. When a selector, such as a cursor, is placed over each of the selectable area, additional selectable choices can be displayed. In particular embodiments, the “home” button 102 does not include a pull-down menu. The “My Profile” button 104 can include a pull down menu for links to a pages for one or more of i) viewing “my profile” (e.g., see FIG. 4), ii) editing “my profile” and iii) viewing “my connections” page (see FIG. 8). The “my resume button” may not have a pull down menu. Its selection can lead to the “add a resume” page (e.g., see FIG. 9). The “connect with employers” button 108 can include a pull-down menu with selectable links to one or more pages that allow i) viewing of information associated with a virtual career fair, ii) viewing lists of companies where selecting a company from the list can lead to a company gateway page (e.g., see FIG. 5), iii) viewing of an event calendar (e.g., FIG. 7 shows an example of an event calendar) and iv) searching for jobs (e.g., see FIG. 6).

The dashboard area 123 can include a number of tools that are available to the user. In particular embodiments, the dashboard area 123 can be configured as collapsible in response to a user selection such that the individual tools are not visible and only the “My Dashboard” bar is visible. Other portions of the page 100, such as the profile and networking portion and recent job postings portion can also be collapsible. Further, dashboard can be configured to allow a user to add or remove tools from the dashboard.

Within the dashboard area 123, the “edit my profile” can be a selectable link that takes the candidate to a page that is configured to allow profile modifications. This link is also found on the page that is generated when the “my profile” button is selected (see FIG. 4). FIG. 4 is discussed in detail after the discussion of FIG. 3 is completed.

The “Add a resume” 126 is a selectable area that allows a candidate to enter a resume into the system. As is shown in FIG. 9, page 180 can be generated when link 126 is selected. The candidate resume page 180 can indicate whether a user has uploaded a resume yet. The candidate resume page 180 may allow a user to search a file system and select a file containing their resume information. A selected file can be uploaded from a user controlled device after the user selects the upload button.

The central system can be configured to enforce file restrictions, such as a file size and type. In the example shown in FIG. 9, the resume is limited to a MS word document of less than 128 kilobytes. In particular embodiment, the central system can be configured to scan the file for viruses and other malware before it is loaded into the system. The central system can be configured to notify the user of any problems associated with the upload process. If a resume file is accepted, it can be uploaded and possibly parsed. In one embodiment, the candidate can be provided an interface that allows the information parsed from the resume to be viewed and possibly edited.

Some of the pages described herein may include user-selectable areas. For instance, a candidate may be able to select industry areas of interest. In another example, a candidate may be to specify tags about themselves (see FIG. 6B). The selectable areas or tags can allow the candidate to be identified in a search carried out on the system. In one embodiment, when a resume is parsed, the system can be configured to automatically check some of the user-selectable areas and determine tags for the candidate. The candidate may be provided with tools to then modify, such as add or delete, this information.

In various embodiments, the central system can be configured to allow a candidate to upload multiple resumes. Further, the central system can be configured to allow a candidate to designate which resume is available for viewing. In one embodiment, the system can be configured to allow candidate to select one resume that is visible to all recruiters. In another embodiment, the system can be configured to allow a candidate to associate a particular resume with particular recruiters. Thus, the system can be configured to allow a candidate to indicate that a first a resume is to be visible to a first recruiter associated with company A but not visible to a second recruiter associated with company B and a second resume to be visible to the second recruiter associated with company B but not visible to the first recruiter associated with company A. In yet other embodiments, all resumes posted by a candidate can be visible to each recruiter that is granted access to the candidate. As described above, a candidate may have to enter through a gateway associated with a recruiter before the recruiter is allowed to view a candidate's resume.

Returning to FIG. 3, the “go to a virtual career fair” 118 can link to a page about scheduled virtual career fairs or to a currently ongoing career fair to which the candidate has access. An example of a virtual career fair calendar page 170 is illustrated in FIG. 7. The candidate may be able to select from a number of scheduled virtual career fairs and view a calendar for the selected career fair by selecting the view button 174. In FIG. 7, a virtual career fair for Entity “A” 172 has been selected for viewing.

The calendar lists different groups and the time period that they are available. In various embodiments, a group can be related to any organization to which a candidate is willing to provide a portion of their time, such as a company, a government agency or a charitable organization. The calendar shows that Group A and Group B are available during one time period on a first day. Group A and Group B are shown scheduled at the same time but could be available at different times. Group C is available during a time period on a second day and group D is available during a time period on a third day.

A “RSVP” button, such as 176, is shown under each group. In one embodiment, selecting the RSVP button, such as 176, may send information to a recruiter associated with a group that an individual is interested. Detailed information about the individual may not be sent and the central system may keep a running tally of the number of respondents. In a particular embodiment, a candidate may not be allowed to talk to a recruiter unless they have RSVP'd ahead of time.

In response to an RSVP, the central system can be configured to send detailed information about a candidate to a recruiter. In response, the recruiter can learn more about a candidate and possibly schedule a specific appointment with the candidate. The specific appointment may be during the career fair times or outside of the career fair times. The recruiter may be able to select filter criterion so that only detailed information about candidates meeting the selected filter criteria are brought to the recruiter's attention.

Returning to FIG. 3, if a virtual career fair is currently on-going and the candidate has been granted access to the virtual career fair, and then in response to a selection of 118, a new page can be generated including a list of groups that are currently available to the candidate. The groups that are available may be different depending on the time that the candidate has entered the virtual career fair because as described with respect to FIG. 7 different groups can be available at different times. Further, as described with respect to FIG. 7, a candidate may have had to RSVP'd to communicate with a particular group. This requirement may vary from one group to another, i.e., some groups may not have this requirement. Thus, list of groups that are displayed may be only the groups that are available to the candidate, such as groups that a candidate has provided an RSVP.

Beside each group can be button that allows a candidate to enter into or participate in a live conversation. The participants and content of the communications can be captured by the central system. After a request to participate in a live communication, the candidate can be routed to an available recruiter and can begin a live conversation with the recruiter via some form of communication, such as a text, audio, video conferencing or combination thereof. If a recruiter is not available, the candidate can be placed in a queue and kept apprised of when a recruiter will be available. If a candidate has entered into a queue and then leaves prior to entering into a conversation with a recruiter, the central system can be configured to notify a recruiter that this event has occurred. In response, the recruiter may attempt to schedule a future communication with the candidate.

In another embodiment, the candidate can enter into a group discussion and possibly view an on-going discussion between a recruiter and one or more other candidates. The candidate may have the option of participating or not participating in the on-going conversation. If a candidate has entered into a group discussion but leaves without participating, the central system can be configured to notify a recruiter of the candidate's interest but non-participation. In response, the recruiter may attempt to schedule a future communication with the candidate.

The central system can be configured to notify the recruiter each time a new candidate has joined into a group conversation. Identifying information may be displayed about each candidate such as their name. In one embodiment, more detailed information about each candidate that is participating can be displayed to the recruiter, such as profile information entered into the system by the candidate. This information can be displayed in a portion of a recruiter interface with information identifying the candidate for which it is associated. This information may not be available in the candidate interface.

The recruiter can be given an option of removing a candidate from a group conversation if they desire or limiting a broadcast of their conversation to less than all members of the group. For instance, when three candidates are engaging in a live conversation with a recruiter, the recruiter can be provided with the option of designating only one or two of the candidate in the group to receive a portion of the conversation. The recruiter can invoke this option temporarily and then after a time period allow the other candidates to again join in. A status indicator can be provided to indicate to the recruiter in regards to which candidates are currently able to receive communications from the recruiter. An advantage of this feature is that during a group conversation, a recruiter can take one of the candidates aside and direct a message that will only be received by the candidate taken aside.

The candidate's interface may be different from the recruiter's interface. For instance, the candidates participating in the group conversation may not be provided information that allows the other participants to be identified. Further, the candidates may not be given full communication access. For instance, when video conferencing is employed the candidate may only be able to see video images of the recruiter but not the other candidates and each candidate may only be able to “hear” the other candidates. However, the recruiter can be provided with the capability to see and hear all of the other candidates. In addition, the candidates may not be given the capability to remove another person from the conversation like a recruiter.

Returning to FIG. 3, a selection of the “view job postings” button 116 may allow a candidate to search for jobs and view jobs postings. An example of the job search page 165 is illustrated in FIG. 6A. In the search job area, a candidate may be able for search jobs by entering descriptive key words. In one embodiment, recent job posting 166 can be listed below the search job area 164. In another embodiment, after a search is conducted, job positions satisfying the key word search can be displayed below the search jobs 164 instead of the recent job posting 166. As shown in FIG. 6A, a returned search can include information about one or more job positions. The information about each job position can include but is not limited to one or more of a company name, a position title, an industry and a job location or region.

The candidate can be provided the option of being able to select certain jobs of interest. The selected jobs can be saved by the central system and later viewed by the candidate. For instant, a selection of a button called, “my saved jobs” may trigger the system to display a candidates saved jobs. In one embodiment, the jobs of interest to a candidate can be displayed in the recent job postings area of the home page 100 illustrated in FIG. 3.

In particular embodiments, all of the saved jobs may or may not be visible to a recruiter. For example, in one embodiment, a recruiter may be able to only to see only the candidates that have save jobs that have been posted by the recruiter or members of the recruiter's team. The recruiter can then be apprised of which candidates are interested in their jobs. However, the other jobs not posted by the recruiter but saved by the candidate may not be visible to the recruiter. In another embodiment, a recruiter may be able to see all of the jobs a candidate has save as an interest to them, whether or not the saved jobs are associated with the particular recruiter.

As shown in FIG. 6A, a search by the candidate can be conducted based upon various input data, such as a “job title,” an employer name, tags, etc. A tag can be a descriptive term entered by a recruiter that can be associated with job. The central system can be configured to allow a candidate to enter tags associated with their job positions. As described above, in one embodiment, the system can be configured to automatically parse some of this information from a candidate's resume. An interface 168 for candidates to enter tags about themselves is illustrated in FIG. 6B. Although not shown, interface can include a feature that allows information automatically parsed by the system to be accepted or rejected by the candidate. A similar recruiter interface can be provided to a recruiter to allow tags about a job position or about themselves to be entered.

As described above, the jobs that a candidate can view may be limited by the gateway that they have used to enter the central system. For instance, in one embodiment, if the candidate has entered through a company gateway then only jobs associated with the company may show up in a search. If the candidate wishes to search on jobs for another company, then the candidate may have to enter through the gateway of another company. For example, the candidate may go to the gateway page illustrated on FIG. 5 to enter into gateways of different companies.

In another embodiment, the system can be configured to allow a candidate to search for jobs from multiple companies. For instance, job search page provided through a community, such as a student/alumni association, may be enabled with the feature. However, as described above, to interact with a recruiter, in some embodiments, the candidate may be required to enter through a company's gateway page.

In yet other embodiments, a candidate may be able to search for jobs associated with each gateway that they have previously entered. For instance, if a candidate enters a first company's gateway, then the candidate can search for jobs from the first company. If a candidate then enters the system via a second company's gateway, then the candidate may be able to then search on the jobs associated with the first company and the second company.

In a particular embodiment, the access capabilities associated with entering a gateway, such as a capability to search for jobs associated with a particular gateway can be time limited. For example, after entering a particular gateway, the candidate may be able to search for jobs associated with the particular gateway for a certain time period. After the time period has expired, the candidate may have to reenter the particular gateway to again access to capabilities associated with the gateway, such as a job search capability. The system can be configured to indicate for a candidate the current active gateway, i.e., the gateway through which they have entered the system. Also, the system can be configured to indicate any other gateways besides the current active gateway for which they currently have access capabilities, such as a job search capability.

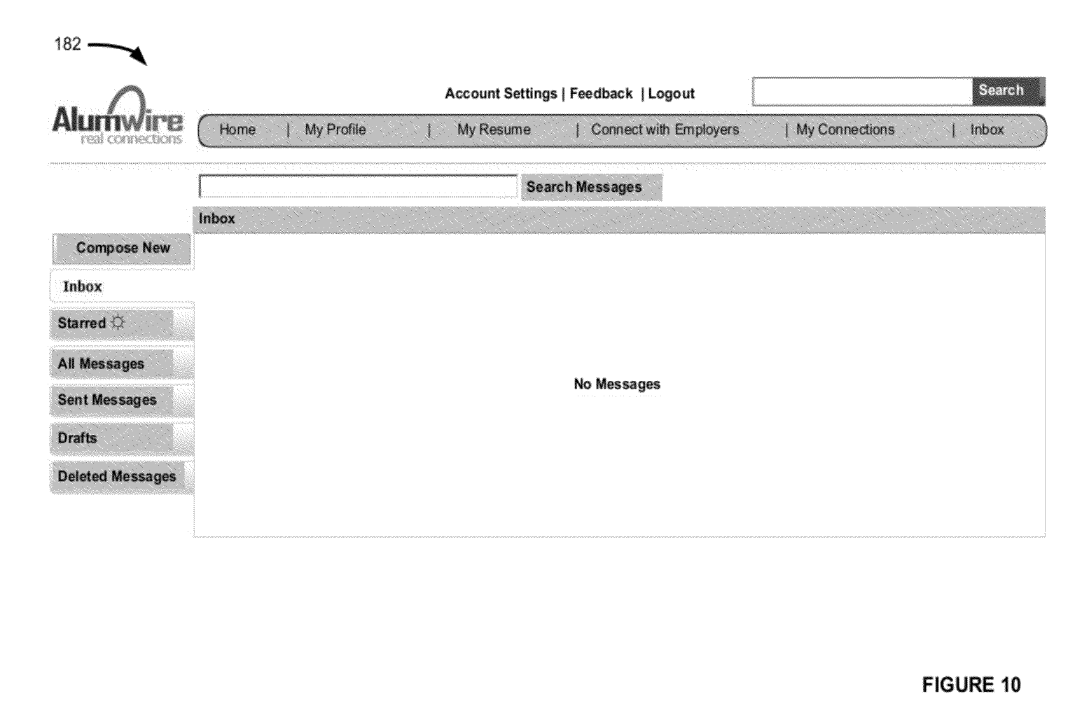

Returning to FIG. 3, in my dashboard 123, the candidate may be able to select the “inbox” button 114. After receiving a selection of the inbox button, the system can be configured to generate a message page for the candidate. An example of a candidate message page 182 is illustrated in FIG. 10.

The candidate message page 182 may allow a candidate to search through their messages. For instance, messages sent to recruiters and received from recruiters. In one embodiment, the candidate may be only allowed to send messages to recruiters and individuals, such as a site administrator, but not other candidates. In another embodiment, the candidate may be allowed to send a message to another candidate if they have established a connection. Prior to establishing a connection, the candidate may be only allowed to send a request for a connection to the other candidate.

The message capabilities can also be linked to gateways. For instance, in one embodiment, the candidate may be only able to send a message to a recruiter that is associated with a current gateway through which they have entered the system. An advantage of this approach is that it makes it harder for a candidate to send a mass mailing to multiple recruiters.

In another embodiment, the candidate may be limited in the number of recruiters that can be addressed on a particular message. For instance, the candidate may be only able to send a message to one recruiter at a time or two or less recruiters at a time. The number of addressees on a message can be limited with the hope that candidates will be more selected in their messaging. In yet another embodiment, the candidate may be only able to send messages to a recruiter only after the recruiter has agreed to accept messages from the candidate. In another example, the candidate may only be able to reply to recruiter messages but not initiate new messages to a recruiter.

Returning to FIG. 10, the message page can include a number of filters. The filters can be configured such that the system displays only message in the inbox, starred messaged, all messages, sent messages, draft messages, deleted messages or combinations thereof. An input button, such as “compose new” can be provided that when selected that allows the candidate to generate a new message.

Returning to FIG. 3, in the profile and networking section 127, an image or an avatar of the candidate can be provided. A button 134 that links to an edit profile page (see FIG. 4) can be provided. In one embodiment, the button can be located below the candidate image or avatar. In response to selection of the button 132, the system configured to display a page that allows the candidate to modify the image or avatar 132.

Under networking 128, links are to a “company profile page” (e.g., see FIG. 5), the “add a resume” interface (e.g., see FIG. 4 or 9) or search for jobs (e.g., see FIG. 6A). A status 136 of the completeness of a candidate's profile, such as a percentage of completeness can be provided. Under profile completion tips 130, a weighting to different parts of the candidate's profile can be indicated. For example, uploading a resume can add 20% to the completeness, providing a description of a talent can add 5% and completing the most proud of section can add 5%. In one embodiment, after the profile completeness reaches a certain level, the parts missing to reach 100% completeness may be listed. For example, after the completeness level reaches 50%, the remaining parts can be listed.

In one section, such as 117, job related information, such as job postings 120 and 122 can be displayed. In one embodiment, the job related information can be recent job posting, such as recent job postings associated with a particular community or job postings associated with the candidate's current gateway, can be listed. In another embodiment, job posting that a candidate has identified as being of interest to the candidate can be listed. The listing can include status information, such as whether the candidate has attempted to contact a recruiter, when the candidate made this contact and whether the recruiter was interested in talking to the candidate.

In particular embodiments, if a candidate attempts to contact a recruiter about a job listing and the recruiter is not interested in the candidate, then the system can be configured to no longer list or allow the candidate to access the job listing. For example, the job listing would not show up in a job search by the candidate even if the job is still available. In another embodiment, if a job position is filled, the system may be configured to notify the candidate of the change in the job status, such as via the candidate's inbox and the job position will be removed from candidate's list of jobs of interest. The system can be configured to send this notification and modify the accounts of all of the candidates that designated the job of interest to them. Next, an example of a candidate profile page is described with respect to FIG. 4.

FIG. 4 is an illustration of a candidate profile page 145. In one embodiment, the system can be configured to generate the candidate profile page 145 when the “My Profile” button or a pull down from the “My Profile” button is selected. The candidate profile page 145 may include an area 146 where resume information can be viewed. If a resume has not been uploaded, then a message “Upload Resume” can be displayed.

The system may allow a candidate to upload multiple resumes. In one embodiment, the resume information stored in the system can be viewed and managed from this page. For instance, the candidate may be able to view each resume that is uploaded and designate one of the resumes as a primary resume that is visible to recruiters. In one embodiment, as described above, the system can be configured to allow a candidate to designate recruiters and/or companies that are allowed to see a particular resume.

In one embodiment, the system can be configured to allow a candidate to upload a “video handshake.” The video handshake may be a brief video clip that introduces the candidate. From this page in area 148, the candidate may be able to view their current video handshake and upload an initial video handshake or change their current video handshake. If a candidate has not uploaded a video handshake, the message “upload your video handshake” can be displayed.

When the edit profile 140 is selected, a page that allows a candidate to edit profile information can be displayed. In particular embodiments, one or more pages can be displayed that allow a candidate to upload a picture and enter personal information, such as hobbies, talents, accomplishments and information regarding other life experiences. Further, a page can be selected that allow a candidate to select from a number of fixed selections different job descriptor information, such as an experience level (e.g., entry level, associate or executive), a commitment level (e.g., full or part-time), an industry of interest (e.g., advertising or social services). Further, the system can be configured to allow a candidate to enter tags, such as a job title (e.g., see FIG. 9).

When the edit settings 142 is selected, a page can be displayed that allows a candidate to change some of their account information, such as but not limited to a first name, last name, email, password, interests and address. In one embodiment, a candidate may be able to specify a status, such as undergrad, alumni, faculty, grad student or staff. This example could be used for a community associated with a university. Other status identifiers can be used for other types of communities. The page generated after edit setting 142 is selected may allow a candidate to change their status.

Interests can be associated with different job related descriptors. For instance, a candidate can designate 1) an industry, such as automotive or IT, 2) a position type, such as entry level, 3) a professional area, such as engineering or nurse or combinations of these designates. The descriptors can be presented as a number of selected categories. On a page that is generated, the system can be configured to allow a candidate to change their selections.

When the add connections button 144 is selected, a page can be generated that allows a candidate to search for other candidates in the system. As examples, a candidate may able to search based on a name, a company or a school. Thus, multiple names can be returned in response to a particular query. After identifying an individual with a possible connection is identified, the system can be configured to allow the user to identify the person as a connection.

In one embodiment, the person associated with the connection does not have to verify or accept the connection. Further, each candidate may not be able to determine whether other candidates have designated them as a connection. For instance, the connection information may be visible to the candidate and recruiters but not other candidates. In another embodiment, a candidate can be notified when another candidate has designated them as a connection but may not be required to accept the connection. In yet other embodiments, when a first candidate designates a second candidate as a connection, the system may be configured to require the second candidate to accept the connection before the first candidate can post the second candidate as a connection.

In one embodiment, the system can be configured to allow a candidate to enter identifying information about the connection. For example, information about the connection can include details of the relationship, such as but not limited to attended school together, friend of a college roommate, worked at the same company, a recruiter or former boss. In one embodiment, the candidate can indicate that a connection is a potential reference that can be contacted by a recruiter. A number for reaching the reference can be provided with the connection. The descriptive information about the connection can be stored and displayed with other information about the connection.

To allow a candidate to view their connections, the system can be configured to generate a page, such as page 178 shown in FIG. 8. In the example shown in FIG. 8, the candidate does not have any connections and no connections are displayed. In one embodiment, descriptive information about each connection can be displayed, such as one or more of an image, a name and relationship descriptors, such as class mate or co-worker.

Returning to FIG. 4, a message board 150 can be provided. A posted message may be available to all recruiters that have access to the candidate's data. In 152, a candidate's personal information can be displayed. As described above in regards to the edit profile setting 140, the personal information may include items, such as outside work interests and achievements. In 152, the candidate has not provided personal information. Thus, a message “add personal information” is displayed in area 152.

In one embodiment (not shown), a candidate may be able to provide an example of a work product. The system can be configured to allow a candidate to upload a work product. The work product can be viewable on the profile page 145 or another page. For instance, the system can be configured to allow a candidate to upload a writing sample or a programmer to upload a programming sample. As another example, the system can be configured to upload a document, such as a power point presentation, that describes a candidate's work product.

Next, an example of a gateway page is described. As was described above, the gateway page can be used by a candidate to connect with employers. As described with respect to FIG. 3, gateways can be used to control, restrict and direct the flow of information in the system. FIG. 5 is an illustration of a gateway page 155.

In one embodiment, the gateway page 155 can include a list of companies, such as 154 and 156. The list of companies can be categorized in some manner. For instance, in 154, Washington, D.C. based employers are listed separately from featured employers 156. In the example in FIG. 5, company A under the feature employers section 156 is shown selected. In response to the selection of company A, the page 155 is branded with the company “A” logo in area 158.

In one embodiment, in response to the selection of Company A, one or more recruiters associated with the company, such as the recruiters shown in area 162, can be notified. If the recruiters are currently on-line, the system can be configured to allow the recruiter to initiate and enter into a live communication with the candidate. The time and participants as well as contents of the live communication can be captured by the system.

If the recruiter is not on-line or is currently occupied with another candidate, then one or more of the recruiters can be notified that a particular candidate has entered into the gateway. If the recruiter does not interact with the candidate before they exit, then the recruiter can attempt to set-up a live communication with the candidate at a later time. In one embodiment, the system can be configured to track how long each candidate spends in a particular gateway and provide a candidate gateway status, such as entered, still present and/or has exited the gateway.

In area 160, a list of representatives, such as recruiters, associated with the company are listed. Images or avatars are associated with each recruiter. In one embodiment, a head of recruiting, such as the “Company A” recruiting can be distinguished from other recruiters under their direction, such as recruiter A and recruiter B. The system can be configured to display additional information about a recruiter when a candidate selects a link associated with the recruiter. For instance, information about a recruiter's job focus areas and/or personal information can be displayed. In particular embodiments, this information can be displayed on the gateway page 155 or a different page.

In one embodiment, the recruiters that appear can be filtered before being displayed on page 155. A large company can have many different job areas, such as accounting, administration, human resources and engineering. Certain recruiters may specialize in job positions associated with a particular area, such as engineering. If a candidate has specified that they are interested in a particular area, such as engineering, or information indicating they are interested in engineering has been parsed from their resume, then the system can be configured to only display the recruiters in the candidate's interest area. For example, if the candidate was interested in engineering and recruiter A specialized in accounting while recruiter B specialized in engineering, then the system can be configured to display only recruiter B.

In general, the system can be configured to display less than all of the recruiters that are associated with a company gateway. In one embodiment, the system can include logic that determines that a company is not interested in a particular candidate. In the case where the company is not interested in a candidate, the system can be configured to not display any recruiters or job openings to the candidate from that company.

After learning about a recruiter, in one embodiment, a candidate may be able to send a message to a recruiter. The message may prompt the recruiter to contact the candidate. The system can be configured so that recruiters can know when a candidate is present but candidates do not know when a recruiter is present. If a candidate and a recruiter are both present, the system can be configured to allow a recruiter to initiate a live communication with the candidate but not vice versa.

In one embodiment, the gateway page 155 can be configured to display job openings 162 associated with a company, such as company A. The system can be configured to let a candidate save information regarding a job of interest to a page associated with the candidate, such as their home page. As described above, the system may be configured to only display jobs associated with a particular company on the company's gateway page. In one embodiment, the system can be configured to only display job openings after the candidate has been approved by a recruiter. In another embodiment, the system can be configured to hold back certain job openings. The held back job opening can be made visible to a particular candidate when the system receives an indication from the recruiter to release the information.

To learn about job openings at other companies, the candidate can select other companies from lists, such as 154 and 156. When the system receives a selection of another company, the gateway page 155 can be updated to reflect the selected company's gateway. For instance, the company logo can be changed, the recruiters can be changed and the job openings can be changed on the page to reflect the new selection. In addition, in response to a selection of a new gateway, the recruiters of the new gateway page can be notified. In one embodiment, the notification may occur after a delay of some period. For instance, the candidate may have to spend at least 5 seconds on the gateway page before the recruiters associated with the gateway page are notified.

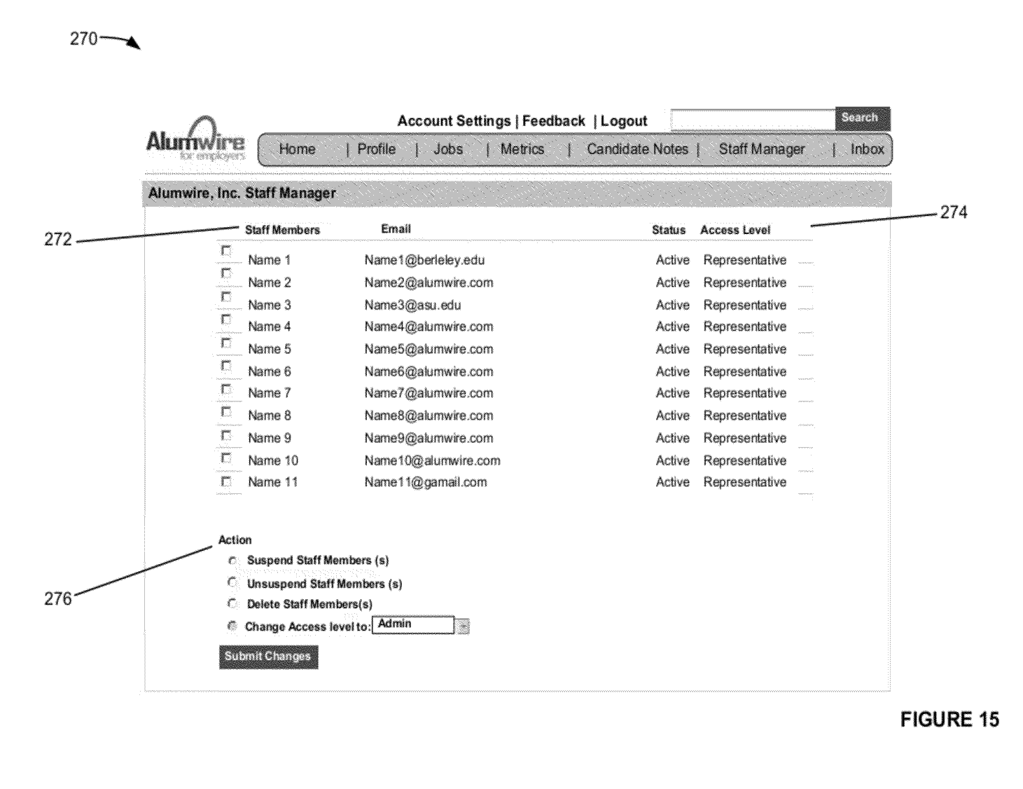

With respect to FIGS. 3-10 examples of a candidate interface were described, such as a candidate's home page. With respect to FIGS. 11-15, an interface for recruiters is described. In one embodiment, a staff manager of recruiters can be provided with an interface that has more options than a recruiter interface without staff manager privileges. A few examples of the staff manager options are described with respect to FIG. 15.

FIG. 11 is an illustration of a recruiter home page 200. A tool bar 201 is provided on top of the home page 200. The tool bar can be repeated on each recruiter page. In one embodiment, the tool bar includes a home button 202, a profile button 204, a jobs button 206, a metrics button 208, a candidate notes button 210, a staff manager button 212 and an Inbox 214.

The selection of the home button 202 can return the recruiter interface to the home page 200. The selection of the profile button 204 can provide a pull down menu with links to a recruiter profile page and a company profile page. The recruiter profile page can be similar to the candidate profile page shown with respect to FIG. 4. It can be used to enter information tailored for recruiters, such as a recruiter specialty.

The company profile page can be used to manage a company profile. For instance, the company profile page can be used to enter information about the company, such as the information shown in FIG. 2. In addition, a video description of the company can be uploaded. In one embodiment, the company profile page can be used to customize as company gateway page as shown in FIG. 2.

The system can be configured to assign multiple privilege levels to recruiters. In one embodiment, a staff manager privilege level can be assigned to a recruiter. The staff manager privilege level may allow the staff manager to add or remove recruiters from the staff. In a particular embodiment, the company profile may only be modified by a recruiter associated with the company that has a staff manager privilege.

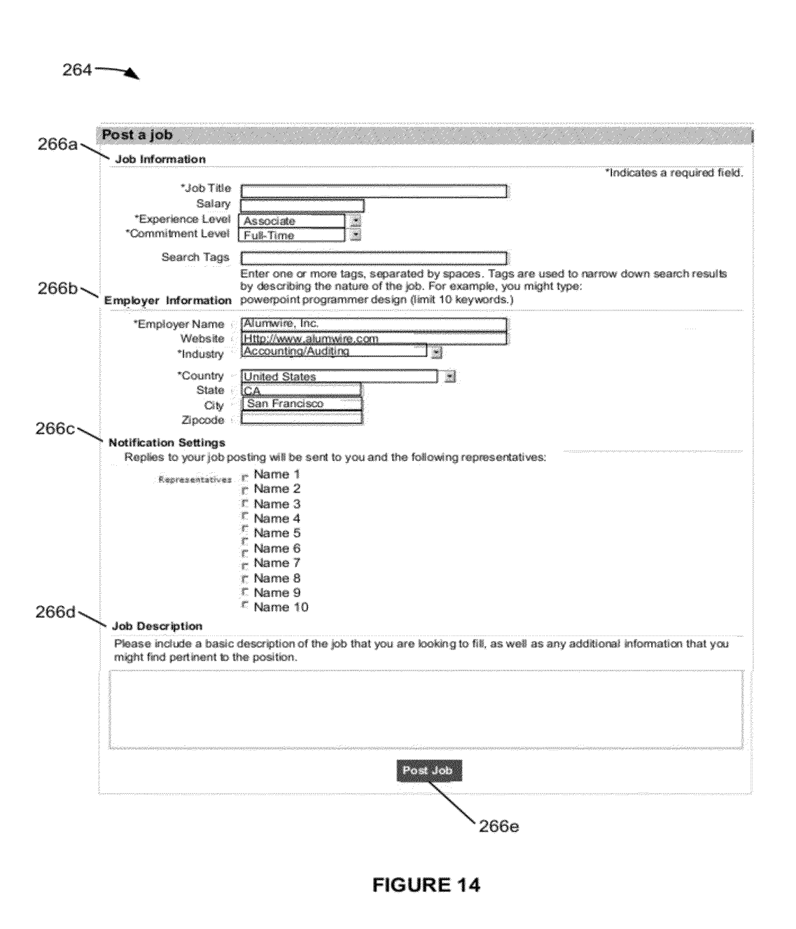

The jobs button 206 can be configured as a pull down menu that allows jobs associated with a recruiting team to be managed. The pull down menu can include a post a job link (e.g., see FIG. 14) and a “manage my job” link. A selection of the “manage my job” link can lead to page with a listing of all or a portion of the jobs that a recruiter is managing. The recruiter can add and delete jobs as part of the management functions. In particular embodiments, the system can be configured to allow a staff manager to view all of the jobs associated with their recruiting team. A recruiter associated with the staff manager may be able to only view their assigned jobs and may not be able to view the jobs of other recruiters on the team. Alternatively, every recruiter on the team can be allowed access to all of the jobs associated with a recruiting team.

The metrics button 208 may allow a recruiter to receive reports with metrics characterizing their recruiting efforts. A selection of this button can lead to a page that allows a recruiter to select different metrics and metric formats to be generated as a report. A staff manager may be able to generate reports associated with one or more recruiters on their team via selecting the metrics button.

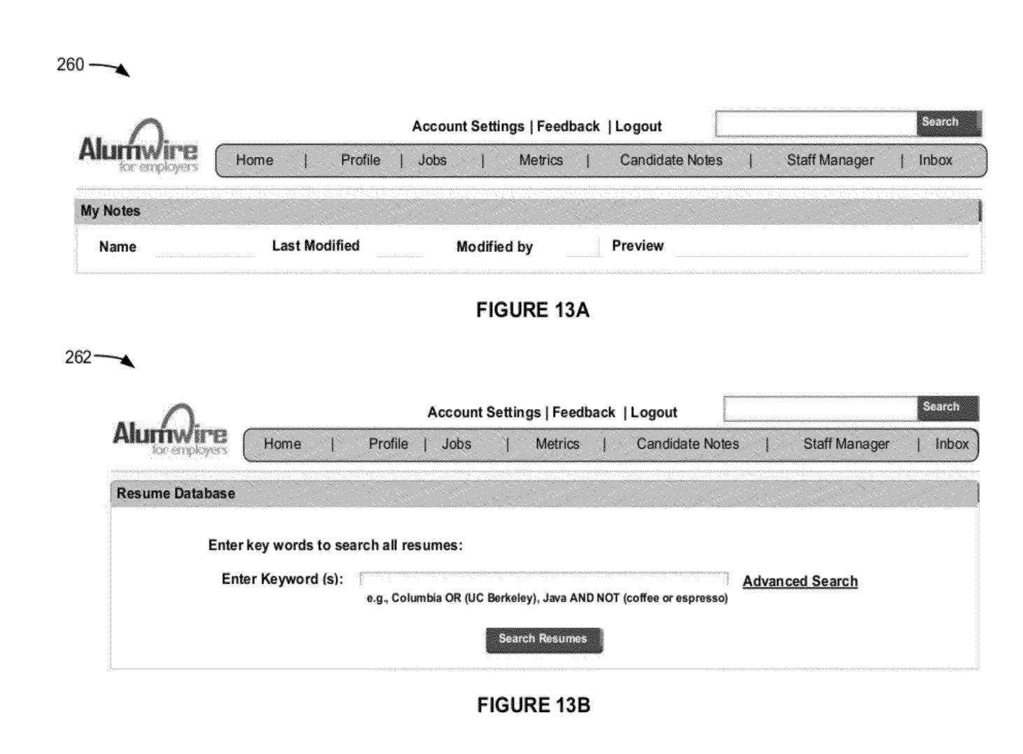

The candidates notes button 210 can lead to a page that allows a recruiter to review and add to notes on individual candidates (e.g., see FIG. 13A). The staff manager button 212 may be displayed only to a recruiter with staff manager privileges or may be disabled if the recruiter does not have staff manager privileges. FIG. 15 is an example of a staff management page 270. The staff management page 270 lists staff members 272 on a recruiter team and such information as each staff members e-mail address, their status and their access level 274.

Via the staff management page, a staff manger may be able to perform different actions 276 related to a recruitment team, such add or delete members, change a privilege level of the team members and temporarily suspend/unsuspend team members. In the example of a community, such as a community of individuals associated with an alumni association (e.g., see FIG. 16) a staff manager page can also be provided. Similar functions can be performed on the staff manager page for a community, such as adding or deleting members of the community and suspending or unsuspending their access to the community.

Returning to FIG. 11, a selection of the inbox button 214 can lead to a message page. The message page can be similar to what is shown and described above with respect to FIG. 10. The dashboard area 215 can include links to functions that are important to recruiters. A selection of each link in the dashboard area 215 can lead to a different page. In one embodiment, the dashboard area 215 can be customizable such that a recruiter can select links to place in their dashboard area.

A first link shown in the dashboard area 215 is for a “post new jobs” button 222. FIG. 14 is an illustration of an example of a job posting page 264 that can be generated when the “post new jobs” button 222 is selected. The “post new jobs” page 264 can include an area 266a that allows a recruiter to post job information. For instance, information such as one or more of a job title, salary, experience level, commitment level and search tags for a specific job can be posted. The interface can be configured such that some of the information, such as a job title is required while other portions of the information, such as a salary, are not required. As described above, in one embodiment, the system can be configured to only allow an individual with staff manager privileges to post a job.

An area 266b on the page 264 is configured to allow employer information to be entered. The employer information 266b can include an employer page, a web-site, an industry, a country, a state, a city and zip code. The industry can be selected from a pull down menu. The employer name, industry and country are designated as required in this example. The other fields are optional.

The notifications settings 266c allow a staff manager to configure which recruiters on a recruiting team are to receive replies to a particular job-position. In one embodiment, the replies can be received by the staff manager alone, the staff manager and one or more recruiters or one or more of the recruiters. The system can be configured to allow changes to these settings after a job is posted as well as when it is first posted.

In area 266d job description can be entered. The job description information can be varied according to the position. Typically, it will be one or more paragraphs. If all the required fields have been filled-in, selecting the post a job button will enable a job to be posted. If some fields have been filled in incorrectly or required data is missing, the system can be configured to identify the incorrect or missing information on the page.

Returning to FIG. 11, the second function in the dashboard area 215 is the search resume button 224. In response to a selection of the search resume button 224, a candidate can be lead to a page that allows a recruiter to search candidate information. For example, FIG. 13B is an illustration of a recruiter candidate information search page 262. In one embodiment, the page 262 may enable a key word search.

As described above, typically each recruiter will have access to candidate information on some sub-set of candidates that have information in the system. For instance, a recruiter may be able to look at all or a portion of the candidates in a community, such as a student-alumni association, associated with the system. The recruiter may have access to candidates associated with a first student-alumni association but not candidates associated with a second student alumni associated. As another example, the recruiter may have access to candidates that have entered into the system through a particular gateway.

In yet another example, a recruiter may have information relating to a database of candidates that have been imported into the system. These candidates may or may not have accounts on the system at present. The recruiter may have received a resume and possibly contacted the candidate in the future. In a particular embodiment, the system can be configured to allow a recruiter to upload information about candidates gathered outside the system including but not limited to identification information, resume information and records of past interactions, such as correspondence between the recruiter and the candidate. In one embodiment, the system may allow a recruiter to upload actual documents associated with the correspondence, such as a paper copy of a resume or a paper copy of a letter between the recruiter and the candidate.

Returning to FIG. 11, the next feature in the dashboard area 215 is a link to a chat booth 226. A selection of the chat booth button 226 may initialize a live communication between the recruiter and one or more candidates. The live communication can involve one or more different form of communications, such as text, audio, video, a whiteboard and combinations thereof. For instance, the communications can involve audio communications while a candidate works on a whiteboard that is visible to both the recruiter and the candidate. As another example, the communications may involve text only, such as instant messaging. In yet another example, the communications may involve video conferencing including audio and video simultaneously.

The system can be configured to capture information regarding the live communications including but not limited to individuals involved, time and date and the actual content of the communications. In one embodiment, the system can be configured to generate transcripts of audio communication, i.e., speech to text capabilities. A search function can be provided to recruiters that allow them to locate and review past communication with candidates. In one embodiment, the search function may allow searches within communications, such as text searches within text transcripts or phrase searches within audio communications.

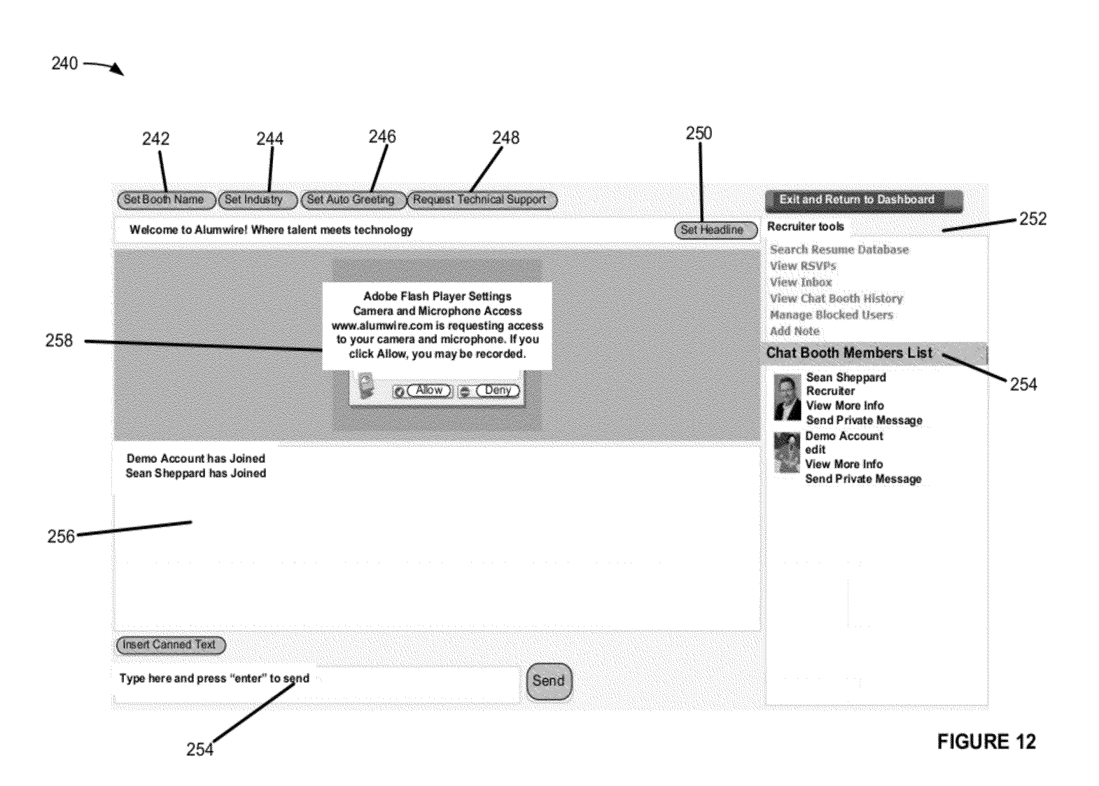

FIG. 12 is an illustration of one example of a candidate/recruiter live communication interface 240. The system can be configured to display this page after a selection of the chat booth button 226 in FIG. 11. In one embodiment, the chat booth page 240 can allow a recruiter to set a booth name, such as a company name, via a selection of the set booth name button 242. Via a selection of the set industry button 244, an industry associated with the chat booth can be selected. Via a selection of the set auto greeting button 246, an automatic greeting can be entered that will be displayed to a person entering the booth.

The page 240 includes a headline. In the example in FIG. 12, the headline is “Welcome to Alumwire! Where talent meets technology!” A selection of the set headline button 250 can be used to change the currently displayed headline. Below the headline is a communication display area 258 where a visual communication component can be displayed. In this area, text, video images or whiteboard data can be displayed.

Below the communication display 258, a live status update area 256 can be provided. The live status update area can indicate when individuals leave and join the chat area. In one embodiment, for multiple candidates, to recruiters the names of all participants will be displayed. To each candidate, however, the names of other candidates may not be displayed. For instance, an anonymous identifier, such as candidate 1 has joined or candidate 2 has left can be displayed. Below the live status update area 256, text messages can be entered in area 254. In one embodiment, when sent, the text message can be displayed in the live status area 256.

On one part of the page 240, a number of recruiter tools 252 can be displayed. A few examples of recruiter tools are a link to search a resume database, such as for the resume of a candidate that has entered the chat booth. A link to view RSVP's, i.e., candidates that have signed up for the chat booth. An example of RSVP's is described with respect to FIG. 7. A link to the recruiter's inbox. A link to the chat booth history. The chat booth history may include a list of all the people that participated in the chat booth and links to content associated with their participation.

A link to manage blocked users can be provided. This link can be used to keep certain candidates out of the chat booth if desired. A link to an add note can be provided. With this link a note about the particular chat session can be generated and stored.

Below the recruiter tools 252, a list of current members is provided. In one embodiment, this information can be available to both recruiters and candidates. It may allow a candidate to see information about a recruiter and possibly send a private message to the recruiter. The recruiter can be provided with similar functions. In other embodiments, a candidate may be able to see information only about the recruiter and send a private message to the recruiter but not to other candidates.

Returning to FIG. 11, the next tool in the dashboard 224 is a link to candidate notes 218. A selection of this link can cause the system to display a page that allows a recruiter to enter notes about a particular candidate. The notes can be entered by multiple recruiters. In one embodiment, links to content can be provided in the notes, such as a link to a video segment from a chat booth session, a highlighted portion of a resume or a portion of a text conversation. In one embodiment, links to sources outside of the central system can be embedded. For example, a link to content in a social media site in which the candidate has provided information can be highlighted.

FIG. 13A is an illustration of a recruiter candidate note page 260. The page can include a candidate name, a specification of when the notes were last modified, which recruiter modified the notes and a preview. The page 260 can include a number of entries for each candidate and entries for multiple candidates.

Returning to FIG. 11, under the profile section 228, links to information related to an individual recruiter's profile as well as a company profile can be placed. For instance, an image of an individual recruiter and a link 230 that allows a profile associated with the account to be edited can be placed in the profile section 228. As an example, after selecting link 230, a page that allows a recruiter to enter personal as well as job related information to be entered (e.g., recruiting specialties, examples of successful placements, etc) can be displayed. In addition, a company logo associated with the account and a link 230 that allows company profile information, such as company information displayed on a gateway page (e.g., FIG. 3), is displayed in the profile section 228.

Below the profile section 228 (different arrangements of the pages shown herein and are provide only for the purposes of illustration), a newest candidates section 234 is shown. In one embodiment, the newest candidate section might list individuals that have entered through a company gateway and include status identifiers, such as but not limited to whether the candidate has been screened or not, whether the candidate has been selected for additional contact or not, whether the candidate has been contacted or not, what recruiter is assigned to contact the candidate, attempts that have been made to contact the candidate, etc.

Below the newest candidates section 234, a recent notes section 236 is generated. The recent notes sections can be notes from one or more recruiters. As one example, the notes might highlight a particular promising candidate, such as why the recruiter thinks the candidate is promising. As another example, the notes can further explain attempts to contact a candidate, such as why a candidate was not reached but an expected time to reach the candidate. In yet another example, the notes may explain why a candidate was rejected, such as prior to an initial contact or after an initial contact.

To the right of the profile section 228, a job posting section 220 is generated. A link 222 to a job posting page, such as a link to page 264 in FIG. 14 can be provided. The job posting section 220 can list jobs posted by a recruiting team including information, such as a title, a location and the recruiter that posted the job.

In particular embodiments, status information can be posted with the job listing. The status information can be posted with the job posting or via links leading to the status information can be posted. Examples of status information may include but are not limited to 1) a list of potential candidates for a job and their contact status (e.g., contacted, not contacted, recruiter that made the contact, when the contact was made), 2) whether interviews of been scheduled, 3) whether an interview was conducted including a time, date an interviewee if it has occurred, 4) whether an offer letter has been sent, 5) interviewer feedback, such as feedback from a hiring manager, 6) notes about individual candidates including possibly links to important candidate information, 7) a ranking or rating of the candidates, 8) a last contact with the candidate and 9) a ranking of the candidates expressed interested (e.g., highly interested, moderately interested, interested, not interested, etc).

FIG. 16A is an illustration of a community page 282 in accordance with the described embodiments. In general, a community can be an open group in which anyone can initially join, a partially open group where any individual that meets certain requirements can join (all people with military service or all graduates of a particular university) or can be a closed group where members are allowed to join after a receiving an invitation. In one embodiment, the community can be associated with an alumni association, such as an alumni association of a university. The alumni association can include current as well as graduated students. Further, the alumni association can include employees associated with the university.

The community page 282 can be part of an interface associated with providing services to the community. The interface can be tuned to different purposes and multiple pages can be provided for different applications important to the community. The community page 282 is one example of a page in a community interface. In one embodiment, the community page 282 may be a home page for the community interface.

The page 282 can be configured to provide links to other pages in the interface that can be used to manage different functions associated with the community. These functions can include but are not limited managing a staff associated with the community, adding and deleting members from the community, inviting members to join a community, communicating within the community including messages to all or a portion of the community, responding to requests from members of the community, sending requests to members of the community (e.g., fundraising) and determining metrics about the community (e.g., participation rate, participation rate by class, participation rate by major).

Some of the functions associated with the community, such as the functions related to managing a staff, can be similar to the functions described above with respect to description of the recruiter interface. For instance, a community manager may be able to add and delete staff and select privileges for the staff as is shown in FIG. 15. The privilege level selected for a staff member may affect their ability to view information associated with individual community members and whether they can add or delete members from the community.

One service that can be provided by a community is helping members of the community find jobs. Thus, in one embodiment, job recruiters can be considered a service provider to the community. In general, a service provider can be an individual or a representative of a group, such as a company, that is allowed to provide goods or services to the community. The community interface can help members find jobs and hence interact with the service provider by providing tools that allow community members to enter company gateways (e.g., see FIG. 5), tools that allows recruiters to see community member information (e.g., resume information as previously described) and tools that facilitate communication between community members and recruiters, such as scheduling virtual career fairs (e.g., see FIG. 7) or allowing community members to communicate with recruiters (e.g., see FIG. 12).

From a manager of community, staff, individuals and companies can be considered as different types of members of the community. The staff manager of the community can be provided with tools that allow each of these types of members to be managed. For instance, tools can be provided that allow a staff manager to grant a company and their representatives access to the community, such as an ability to see information regarding all or a portion of the members in a community. FIG. 16B is an illustration of a community manager page 284. This page allows a staff manager to view account information associated with different members of the community and locate members of the community. In one embodiment, separate pages can be provided for community members and employers, such as company representatives.

FIG. 17 is a flow chart of a method 300 in a system of communication management and capture involving recruiters and candidates. In 302, the system can receive registration information from a candidate. In one embodiment, the system can initially receive candidate information via a registration on a gateway page (e.g., see FIG. 3). Following the registration, the candidate can provide additional information to specify their profile. In another embodiment, a candidate may be accepted into a community and establish their profile as part of the community.

In yet another embodiment, a recruiter can be provided an interface that allows candidate information previously received by the recruiter to be entered into the system. The recruiter can maintain a candidate profile via this interface. When a recruiter supplies and maintains information for a candidate, the candidate may not be able to see or update this account. Thus, two types of candidate accounts can be provided, one that is maintained by the candidate and can be modified by the candidate and one that is maintained by a recruiter and can be modified by the recruiter.

In 304, candidate information can be associated with different recruiter databases. For instance, when a candidate enters a company gateway, then the candidate information may be stored such that it is only accessible to recruiters associated with the company gateway but not other recruiters. In another example, a member of a community can be a candidate. In this case, the candidate information can be shared by a number of recruiters associated with different companies, such as companies approved by the community.

In yet other embodiments, an individual recruiter may be able to enter candidate information that is only available to the individual recruiter. For instance, a recruiter may maintain a proprietary database of candidate information that is only available to the recruiter. In one embodiment, a mechanism can be provided on the system that allows one recruiter to share candidate information with another recruiter. For instance, the system can allow a recruiter to send information stored in their proprietary database to another recruiter so that it can be added to their proprietary database.

In 306, a determination can be made as to whether a candidate is of interest to a particular recruiter. For example, an alumni association can include candidates with all different types of backgrounds. Certain companies and employers may only be interested in candidates with certain backgrounds. The system can be configurable to allow a recruiter to apply filters to incoming candidate data. The filters can be optionally used to screen potential candidates such that only candidates meeting the filter criteria are brought to the attention of the recruiter.

In 308, when a candidate is of interest to the recruiter, then one embodiment, a recruiter can be notified. In one embodiment, the notification can be made in real-time. For instance, a candidate can enter a gateway page and the system can notify an available recruiter that a candidate of interest is currently on-line. In another embodiment, the system can be configured to determine that a currently identified candidate is on-line via some other mechanism than the system, such as the candidate is logged-on via a social media page, and the system can be configured to notify the recruiter that candidate is on-line and possibly available for a communication.

In 310, the system can be configured to allow a recruiter to initiate an interface that allows a live communication between a candidate and a recruiter to be initiated and captured. In one embodiment, the interface may only be initiated by the recruiter. The communication interface can be initiated between the recruiter and the candidate when both currently on the system, such as when the candidate is in the system via a gateway page. In another embodiment, the system can be configured to generate an interface that invites the candidate into the system. For example, when the candidate can be on-line via other mechanisms and the system can be configured to allow a recruiter to send an invitation to the candidate. The invitation can be structured such that when the candidate accepts the invitation it brings the candidate into the system. For instance, the invitation could be a text message with a URL or phone number that provides a gateway into the system.

In 312, for a communication that is processed through the system, information regarding the communication, such as when it occurred, the participants and the content can be captured. In 314, the system can be configured to receive from a recruiter a request for information related to one or more previous candidate/recruiter live communications. For instance, the recruiter may be trying to locate a transcript of a text communication that occurred between a recruiter and a candidate on a previous date. In one embodiment, only recruiters and not the candidates may be able to access this type information on system. In 316, the system can output the requested information related to the previous one or more candidate/recruiter communications.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling a computational device, such as computer system with a processor, a memory and a user interface. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A system comprising:
a processor, a memory and a network interface configured to: 1) generate a plurality of gateways used by candidates wherein a candidate's entrance through a particular gateway is used to determine which recruiter selected from a group recruiters registered with the system can access the candidate's data; 2) generate a candidate interface for a) receiving job related information wherein each candidate is able to see their job related information but not the job related information of other candidates, b) viewing information about individual recruiters within the group of recruiters, c) establishing indications of relationships with the recruiters or other candidates, and d) entering into a live conversation with the recruiter, 3) generate a recruiter interface for i) searching the job related information received from a plurality of different candidates, ii) initiating the live conversation with one or more candidates, iii) reviewing content captured from a past live conversation with at least one of the candidates, iv) establishing indications of relationships with the candidates or other recruiters and v) manage a team of recruiters and 5) capture the live conversation between the candidate and the recruiter wherein content captured from the live conversation between the recruiter and one of the candidates is only available for review by the recruiter.

2. The system of claim 1, further comprising: a plurality of proprietary databases each including candidate information associated with a portion of the candidates wherein access to a first proprietary database limited to a first group of recruiters and access to a second proprietary database is limited to a second group of recruiters.

3. The system of claim 2, wherein the first group of recruiters is associated with a first company and the second group of recruiters is associated with a second company.

4. The system of claim 1, wherein a first gateway is associated with a first company and a second gateway is associated with a second company

5. The system of claim 4, wherein after entering via the first gateway a particular candidate is allowed only to see jobs and interact with recruiters associated with the first company and wherein, after entering via the second gateway, the particular candidate is allowed to see jobs and interact only with recruiters associated with the second company.

6. The system of claim 1, wherein an interface is provided with one or more of the plurality of gateways that allows a particular candidate to register for an account with the system or to access a previously registered account with the system.

7. The system of claim 1, wherein the system is configured to allow the candidates to communicate with the recruiters but not directly with the other candidates.

8. The system of claim 1, wherein the system is configured to allow the candidates to see their own established relationships with the recruiters or the other candidates but not to the established relationships of the recruiters or the other candidates.

9. The system of claim 1, wherein the recruiter interface is further configured for generating and outputting metrics related to a performance of a recruiting team or an individual on a recruiting team.

10. The system of claim 1, wherein the system is further configured to notify one or more recruiters associated with a particular gateway when a particular candidate has entered the system via the particular gateway.

11. A system comprising:
a processor, a memory and a network interface configured to: 1) generate an staff interface that allows a staff to manage membership in a community wherein the membership includes members of the community and individuals associated with service providers desiring to provide services to the members and wherein the staff interface allows members to be added or deleted from the community and the individuals associated with the service providers to be added or deleted from the community; 2) generate a communication interface that allows content associated with a live communication between a particular member and a particular individual associated with a particular service provide to be captured and subsequently reviewed; 3) generate an interface that allows members to enter personal information and the individual associated with the service providers to enter personal information and information associated with the service provider; 4) generate an interface that allows the individuals associated with the service provides to view all or a portion of the personal information provided by one or more of the members of the community; and 5) generate an interface that allows the members or the individuals associated with the service providers to establish and identify a relationship with other members of the community or other individuals associated with associated with the service providers.

12. The system of claim 11, wherein the community is an alumni association associated with a university and wherein the members include active students, graduates and employees of the university.

13. The system of claim 11, wherein the individuals associated with the service providers are recruiters associated with companies desiring to recruit the members for jobs.

14. The system of claim 11, wherein the personal information includes job related information.

15. The system of claim 11, wherein the job related information is a resume.

16. The system of claim 11, wherein the system is further configured to generate a virtual career fair that allows members to remotely interact with recruiters from companies at scheduled times.

17. A method for a job recruiting system comprising:
generating a plurality of gateway pages each of the gateway pages associated with a different company;
receiving from a candidate at a first gateway page associated with the first company a request to register with the job recruiting system or enter the job recruiting system via the first gateway page;
associating the candidate with the first company;
generating a candidate interface that allows the candidate to enter job related information including a resume into the job recruiting system and view job related information only associated with the first company; and
generating a recruiter interface that allows only a recruiter associated with the first company to interact with the candidate.

18. The method of claim 17, further comprising:
notifying the recruiter associated with the first company that the candidate has registered or entered into the job recruiting system.

19. The method of claim 18, further comprising:
notifying the candidate that the recruiter wishes to communicate with the candidate and generating a communication interface that enables the recruiter and the candidate to enter into a live communication.

20. The method of claim 19, further comprising:
capturing content associated with the live communication including one or more of text, audio and video images.
